(19) United States
(12) Patent Application Publication
(10) Pub. No.: US 2014/0308637 A1
(43) Pub. Date: Oct. 16, 2014

(54) METHODS AND APPARATUSES FOR FACILITATING A CHANGE FOR AN INDIVIDUAL

(71) Applicant: AARP, Washington, DC (US)

(72) Inventor: Emilio PARDO, Silver Spring, MD (US)

(73) Assignee: AARP, Washington, DC (US)

(21) Appl. No.: 14/253,356

(22) Filed: Apr. 15, 2014

Related U.S. Application Data
(60) Provisional application No. 61/812,076, filed on Apr. 15, 2013.

(51) Int. Cl. H04L 29/08

(52) U.S. Cl. CPC H04L 67/22
USPC 434/236; 709/204

(57) ABSTRACT

Methods and apparatus for facilitating a change for an individual. The methods and apparatus may include determining a current stage of change for an individual based upon information received about making a change. The methods and apparatus may also include setting up a sounding board to communicate with a select number of individuals to receive feedback and/or advice for facilitating a change.

### RELATED APPLICATION

This application claims priority to U.S. Application No. 61/812,076 titled “Methods and Apparatuses for Facilitating a Change for an Individual,” filed Apr. 15, 2013, which is incorporated herein by reference in its entirety.

### BACKGROUND

As individuals age, individuals may experience a change in their lives and/or may want to make a change. For example, individuals may want to try something new, such as a new job, hobby, eating healthier, etc. However, deciding when and how to make the change may be a difficult process that may require help. In addition, individuals may need help and/or guidance to complete the desired change.

Thus, there remains an unmet need in the art to aid individuals in making a change.

### SUMMARY

Aspects of the present invention relate to methods and apparatuses that, among other things, facilitate a change for an individual. Aspects of the present invention also relate to methods and apparatuses that determine which stage of change an individual may be at and may provide activities and content to aid the user in making the change. In addition, aspects of the present invention may relate to methods and apparatuses that allow an individual to set up a sounding board to share information with sounding board members and ask for advice and help from sounding board members in making a change.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates an example system in accordance with an aspect of the present invention;

FIG. 2 illustrates an example method flow for facilitating a change in accordance with an aspect of the present invention;

FIG. 3 illustrates an example method flow for determining a current stage of change for an individual in accordance with an aspect of the present invention;

FIG. 4 illustrates an example method flow for setting up a sounding board in accordance with aspects of the present invention;

FIGS. 5A-5Z and 5a-5h illustrate example interfaces for use with aspects of the present invention;

FIG. 6 illustrates various features of an example computer system for use in conjunction with aspects of the present invention; and

FIG. 7 illustrates an exemplary system diagram of various hardware components and other features for use in accordance with aspects of the present invention.

### DETAILED DESCRIPTION

Aspects of the present invention relate to methods and apparatuses that facilitate a change for an individual. Changes may include, but are not limited to, a career change, a relationship change, developing better habits, getting organized, simplifying aspects of life, eating healthier, developing a new hobby or skill set, realizing a dream, or rediscovering talents.

Among other things, the methods and apparatuses may aid a user in determining what change(s) the user may be interested in making, provide activities to aid the change(s), and provide a forum to share any progress in making the change(s) and/or receive help in making the change(s).

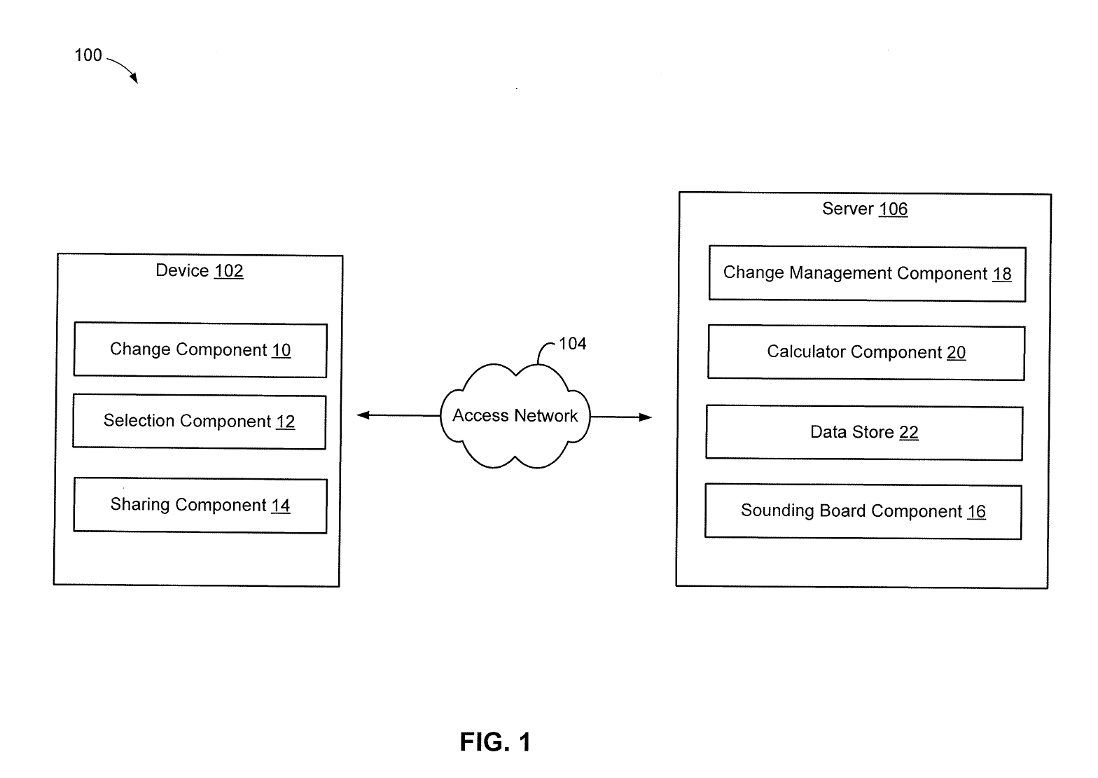

Referring now to FIG. 1, illustrated therein is an example system to facilitate change in accordance with an aspect of the present invention. System 100 may include one or more devices 102 communicating through one or more access networks 104 with one or more servers and/or computing devices 106. Device 102 may include any suitable wired or wireless computing or communications device, such as a cellular telephone, a navigation system, a computing device, a camera, a personal digital assistant (PDA), a music device, a gaming device, or a handheld device having wireless connection capability, among other devices. Server/computing device 106 may include any mobile or fixed computing device connected to a network. Furthermore, access network 104 may provide one or more types of communication connections, such as any type of wireless airlink, to device 102 and server 106.

Device 102 may include a change component 10 for aiding a user in facilitating a change. Change component 10 may allow a user to discover new possibilities for making a change, determine what may be necessary to make a change, and/or aid a user making a change. A user may be an individual using the system to make a change. In addition, a user may be a person acting on behalf of the individual, or a group of individuals, wanting to make a change.

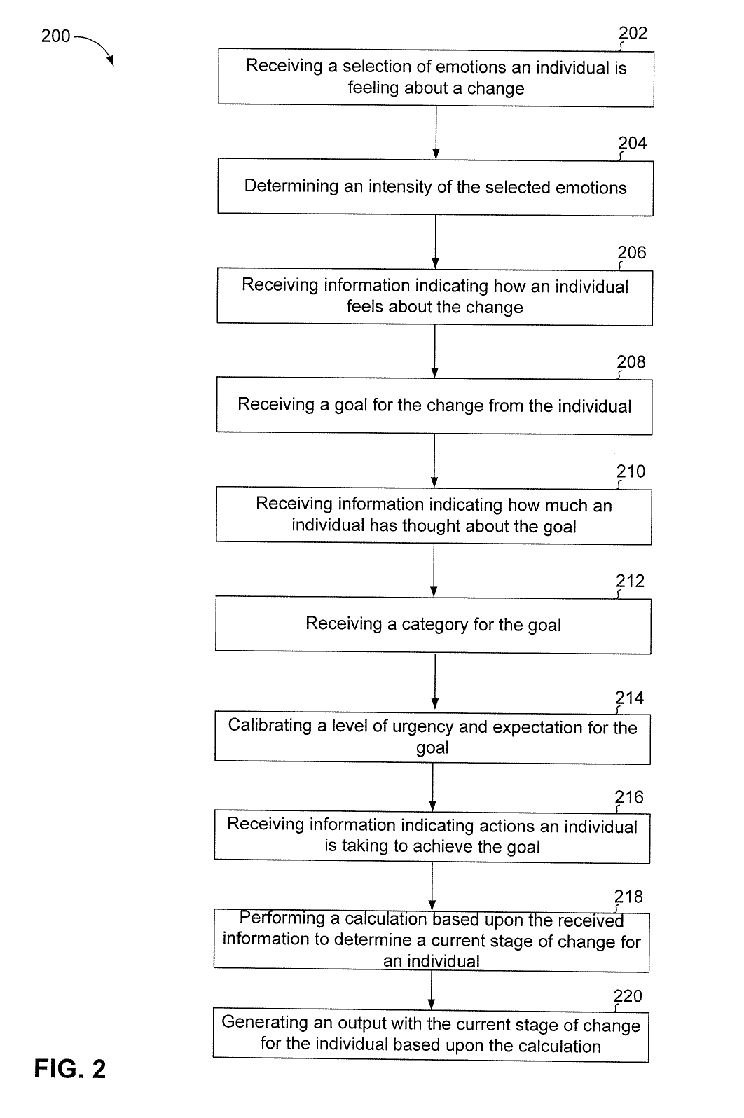

Change component 10 may interface with server 106. Server 106 may include a change management component 18 for aiding a user in facilitating a change. Change management component 18 may transmit a diagnostic experience to change component 10 to allow a user to understand where a user may be in a journey of making a change. A diagnostic experience, as discussed in more detail in conjunction with FIG. 2, may determine a current stage of change for an individual based on various inputs and/or selections received from the individual. Change component 10 may present the diagnostic experience to the user. For example, the diagnostic experience may present the user with various questions and/or opportunities for the user to provide information about a goal and/or potential change the user may want to make. Change component 10 may interface with a selection component 12 to receive any inputs and/or selections from the user. Change component 10 may transmit the received inputs and/or selections to change management component 18.

Change management component 18 may interface with a calculator component 20 to determine a current stage of change for the user. In an aspect, calculator component may apply weights to the information received by the user and perform a calculation to determine a current stage of change based upon the received information. Change management component 18 may also retrieve content and/or activities that may be relevant to the current stage of change to transmit to change component 10. For example, the content and/or activities may aid a user in making the change. In addition, the content and/or activities may be tailored to the user based on the current stage of change for the user. In an aspect, change management component 18 may retrieve the content and/or activities from data store 22. Change component 10 may receive the content and/or activities and present the received content and/or activities to the user.

In an aspect, change component 10 may interface with a sharing component 16 to allow the user to connect with other individuals. For example, sharing component 16 may allow the user to share the received content and/or activities with other individuals. In addition, sharing component 16 may allow a user to share their goals, current stage of change, content received, and/or other information from the system with other individuals. For example, sharing component 16 may, e-mail the information to the other individuals, share the information via social media accounts, or post the information on a weblog.

Change component 10 may also interface with a sounding board component 16 for providing an interface where a user may select individuals to include in a sounding board to receive feedback and/or advice for facilitating a change.

Referring now to FIG. 2, therein illustrated is an example method flow 200 for facilitating a change in accordance with an aspect of the present invention. The method may include receiving a selection of emotions a user is feeling about a change 202. A user may be an individual using the system to make a change. In addition, a user may be a person acting on behalf of the individual, or a group of individuals, wanting to make a change. For example, the system may present on an interface various emotions a user may be feeling about a change and the user may receive, via the interface, a selection of emotions the user is feeling. Emotions may include, but are not limited to, optimistic, energized, alone, passionate, inspired, uninspired, cautious, overwhelmed, discouraged, indecisive, on top of it, at loose ends, confused, and unprepared. In an aspect, the user may select three emotions, for example, from a selection of fifteen to illustrate the user's emotions.

The method may also include determining an intensity of the selected emotions 204. In an aspect, the system may present on an interface a sliding scale where the user may select an intensity of the selected emotions and may receive a selected intensity from the user. For example, the scale may range from slow and steady at the bottom of the scale to building steam in the middle of the scale and full throttle at the top of the scale. In another aspect, the system may receive an input, such as a number (e.g., 0 to 10) or text (e.g., low, medium, high) indicating an intensity of the selected emotion.

The method may also include receiving information indicating how a user feels about the change 206. For example, the system may present on an interface a selection of feelings about the change and the system may receive a selection of the presented feelings from the user. Example feelings may include, but are not limited to, “I am worried about money,” “The logistics are overwhelming,” “Am I healthy enough?,” “I get energized by being with a group of people,” “I have to take a chance to get what I want,” “My gut is telling me to go for this,” “I have a lot to do before I can dive into this change,” “I wonder if this will work out the way I imagine it,” “The sky is the limit,” “I'm three steps ahead of the game,” “So many ideas, so little time,” “I have so many good ideas—how do I decide?,” “I guess it cannot hurt to try,” “I really do not have time to do this change,” “Is this change really possible?,” “Starting over is hard,” “There is a lot to consider before I commit,” “What's the right choice for me?,” “I should be doing something else,” “I wonder if my spouse will mind if I spend time on this,” “Does anybody ever meet deadlines?,” “My idea is hidden in the mess,” “How am I going to keep track of things?,” “How am I going to keep track of things?,” and “I hope there is not any homework involved.”

The method may include receiving a goal for the change from the user 208. In an aspect, the system may present on an interface an opportunity for a user to enter a goal for the change and may receive an entered goal. For example, if the change the user wants to make is a new job, the user may enter a goal of “opening a new cupcake shop.”

The method may include receiving information indicating how much a user has thought about the goal 210. For example, the system may present on an interface a selection of thoughts a user may have about the goal and may receive a selection of the thoughts from the user. In an aspect, the system may present four thoughts for the user to select one from. Example thoughts may include, but are not limited to, “I am not sure what I want,” “I have a basic idea of what I want,” “I do not know which change to tackle first,” and “I know exactly what I want to do.”

The method may include receiving a category for the goal 212. For example, the system may present on an interface a plurality of categories and may receive a selected category for the goal from the user. Categories may include, for example, work/career, health/fitness, relationship, and hobbies. In addition, the user may be able to enter a different category for the goal. The system may use the categories entered to provide additional content and/or information to the user. For example, the system may provide weekly e-mails to the user with content tailored to the category of the goal (e.g., new job, new hobby, relationships, and organization). In addition, the category information may be used by the system to determine a critical mass of goals and/or determine emerging trends on the horizon. For example, the system may determine that a critical mass of individuals is selecting cooking as a new hobby.

The method may also include calibrating a level of urgency and expectation for the goal 214. The system may receive input from a user indicating a level of urgency for the goal. For example, the system may present on an interface a time line for when a user may want to achieve the goal. The time selected by the user may be used by the system to determine the timing of the change (e.g., a more immediate change or further down the road). Another example may include receiving text from a user indicating the level of urgency (e.g., within a year, ongoing, 1-3 years).

The method may include receiving information indicating actions a user is taking to achieve the goal 216. Actions may include, but are not limited to, waiting for the right moment, getting the details right, second-guessing myself, looking for feedback, avoiding the whole idea, choosing not to compromise, doing things for the sake of doing something, hoping inspiration will strike, nothing, daydreaming, sharing my ideas with others, focusing on the big picture, ignoring naysayers, asking family and close friends what they think, going in a hundred different directions, and fitting this in between other responsibilities. For example, the system may present on an interface a variety of actions a user may take to achieve a goal and receive a selection of actions from the user. In an aspect, the system may present sixteen actions, for example, that the user may be taking and request that the user select three actions.

The method may include performing a calculation based upon the received information to determine a current stage of change for the user 218. For example, the calculator component 20 (FIG. 1) may apply a weight to the information received by the user and calculate a current stage of change based upon the received information. In an aspect, calculator component 20 may apply various points to the information received. For example, a higher number of points may be allocated for a more goal oriented response and/or a high intensity while lower points may be allocated for a lower intensity response. If, for example, the user selects “optimistic” as an emotion, the calculator component may apply a higher point value (e.g., 5 points) than if the user selects “uninspired” (e.g., 2 points). Another example may include applying a number of points based on the type to question asked. For example, a question about a category of a goal may receive a lower number of points (e.g., 1 point) in comparison to a question where a user inputs a goal, which may receive a higher number of points (e.g., 10 points). In an aspect, calculator component 20 may apply a binary value to the information received (e.g., 1 or 0) based on a set of rules for the information received. In an aspect, calculator component 20 may apply points to a subset of the answers received by the user in calculating the current stage of change for the user. Calculator component 20 may determine a current state of change based on the points calculated. For example, each state of change may have a point range assigned to the state of change. As such, calculator component 20 may calculate the points associated with the information received by the user and compare the points to the point range assigned to the state of change to determine the current state of change for the user.

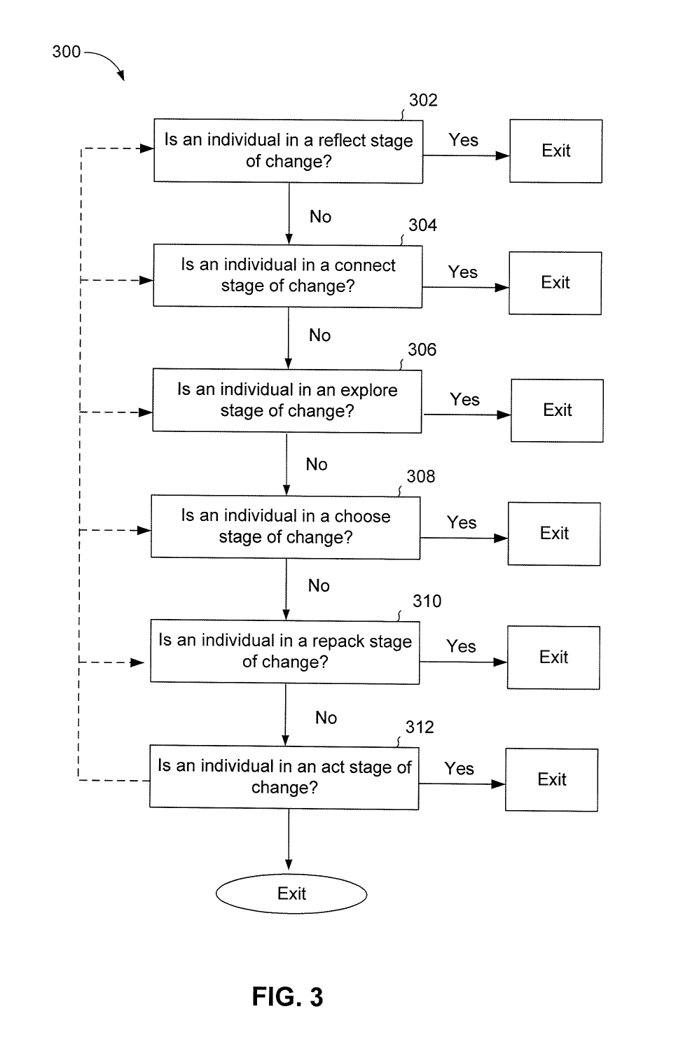

Referring now to FIG. 3, illustrated therein is a method 300 for determining a current stage of change for an individual in accordance with an aspect of the present invention. The method may include determining whether an individual is in a reflect stage of change 302. The reflect stage of change may be, for example, when an individual takes inventory of where the individual is in life and may gain clarity about what a next move may encompass. The reflect stage of change may prepare an individual to consider ways in which plans may affect the life of the individual and share experiences to help plan a next move. Among other things, the system may determine whether the individual is in a reflect stage of change.

The method may include determining whether an individual is in a connect stage of change 304. A connect stage of change may be, for example, when an individual is ready to connect with others to share ideas, consider new perspectives, and interact with a group of people to help facilitate the change. Among other things, the system may determine whether the individual is in a connect stage of change.

The method may include determining whether an individual is in an explore stage of change 306. An explore stage of change may be, for example, when an individual may discover and bring new possibilities into the individual's life by thinking broadly and curiously about where life may go. For example, the explore stage of change may allow an individual to think outside the box, challenge assumptions, reenergize interests, discover new opportunities, build on initial ideas, and imagine possibilities open to the individual. Among other things, the system may determine whether the individual is in an explore stage of change.

The method may include determining whether an individual is in a choose stage of change 308. A choose stage of change may be, for example, when an individual may commit to a change by choosing a direction to shape the individual's life. For example, an individual may clarify what is important to the individual and reassess how current priorities match up with a goal and/or purpose. Among other things, the system may determine whether the individual is in a choose stage of change.

The method may include determining whether an individual is in a repack stage of change 310. The repack stage of change may be, for example, when an individual may determine what is necessary for achieving a goal, what is not necessary for achieving a goal, and an individual may change and/or reprioritize priorities in order to achieve the goal. Among other things, the system may determine whether the individual is in a repack stage of change.

The method may include determining whether an individual is in an act stage of change 312. An act stage of change may be, for example, when an individual is ready to make the change happen. Among other things, the system may determine whether the individual is in an act stage of change. It should be noted that individuals may move among the various stages of change.

Referring to FIG. 2, the method may include generating an output with the current stage of change for the user based upon the calculation 220. For example, the system may present on an interface the current stage of change for the user. The current stage of change may include, for example, a reflect stage, a connect stage, an explore stage, a choose stage, a repack stage, and an act stage. It should be noted that the current stage of change may have a plurality of categories. For example, a reflect stage of change may have two different categories, while an act stage of change may only have a single category. As such, the current stage for the user may be a reflect stage category one.

In addition, the system may present on the interface various activities a user may take in connection with the stage of change. Activities may include, but are not limited to, outlining a purpose, taping experiences, finding a calling, expanding possibilities, preparing for “Plan B,” making a to do list, expanding a network of individuals, setting up a sounding board, identifying values, getting organized, narrowing down choices, delegating items, planning ahead, and clearing obstacles.

The system may also present on the interface content that may be tailored to the stage of change and may aid the user in making the change. Content may include, but is not limited to, articles, blogs, videos, recommendations, tips, and games. It should be noted that the content may be original content or curated content, for example. For example, the content may include videos and blogs for avoiding procrastination. Another example of content may include an article on handling bumps in the road of making a change. In an aspect, various thought leaders may provide the content, help develop the content, and/or help curate the content selected for presentation to users.

The system may also provide an interface for the user to connect with other individuals. In an aspect, the user may share information from the system with other individuals. The system may have a sharing component that allows a user to share their goals, current stage of change, content, or other information from the system with other individuals. For example, the user may, e-mail the information to the other individuals, share the information via social media accounts, or post the information on a blog.

In addition, the system may provide an interface for a user to setup a sounding board for the user to communicate with a smaller audience of individuals.

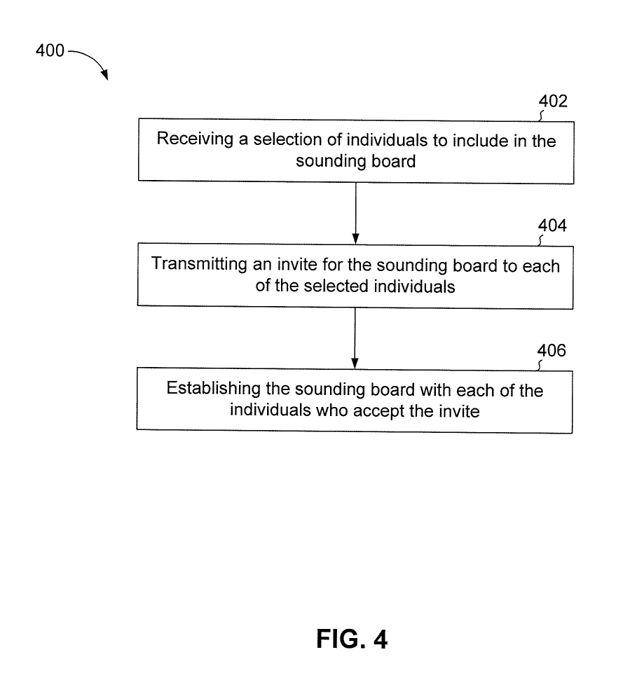

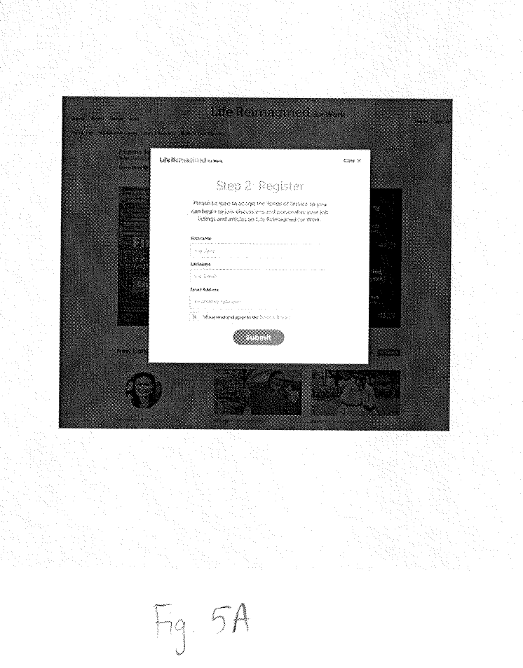

Referring now to FIG. 4, illustrated therein is a method flow 400 for establishing an example sounding board in accordance with an aspect of the present invention. The sounding board may provide a user with a forum to communicate with a select number of individuals, for example, such as to receive feedback and/or advice for facilitating a change.

The method may include receiving a selection of individuals to include in the sounding board 402. The user may select individuals with a variety of life experiences and points of view to help the user achieve the change. For example, the system may present an interface where a user may select various individuals to include in the sounding board. Individuals may include, but are not limited to, friends, family members, work colleagues, teachers, advisors, and mentors. In addition, individuals selected for the sounding board may include: individuals who genuinely are interested in the user and want to see the user succeed (e.g., number one fan); individuals who are not interested in fixing the user but who love the user as is (e.g., genuine supporters); individuals who stay focused on the user's needs (e.g., great listeners); individuals who ask insightful questions to help the user find the answers without telling the user what the user needs to do (e.g., gurus); individuals who always tell the user the truth plain and simple (e.g., straight shooters); and individuals who are willing to give the user a nudge in the right direction (e.g., motivators). In an aspect, a user may select one individual from each category to include in the sounding board (e.g., 6 individuals). Alternatively, the user may select a lower number of individuals to include in the sounding board or a higher number of individuals to include in the sounding board. In addition, the individuals may be dynamically added to the sounding board and/or removed from the sounding board by the user.

The method may also include transmitting an invite for the sounding board to each of the selected individuals 404. The invite may be a message, such as an e-mail message or SMS message, with instructions for the individual to accept and/or decline the invitation to join the sounding board. In an aspect, the system may receive contact information for the selected individuals and send the invite to the contact information for the selected individuals. For example, the system may receive the individuals' contact information (e.g., e-mail addresses or telephone numbers) from the user. In another aspect, the system may interface with various social media accounts of the user (e.g., Facebook, Linkedin, and Twitter) or address books of the user (e.g., e-mail account address books, cellular telephone address books) and access the contact information from the social medial accounts.

The method may also include establishing the sounding board with each of the individuals who accept the invite 406. For example, the system may establish the sounding board upon a single individual accepting the invite and may add additional individuals as they accept the invite. The system may present the status of the invites on the interface. The status may include, for example, invite sent, invite accepted, and invited declined.

Once the sounding board has been established, the system may provide an interface for the user to have conversations with the sounding board members, to share information with the sounding board members, to ask for advice, and/or receive help from the sounding board members, for example. Specially, for example, the user may want to share the results of various activities the user has completed by using the sounding board forum. The sounding board may also be used to provide content to the user. For example, sounding board members may share videos, articles, and blogs with the user to help the user achieve the change. In addition, the user may want to have a conversation with the sounding board members to ask a question about making the change. In an aspect, the conversations may be threaded so that the sounding board members may follow the conversation and see how other members have commented.

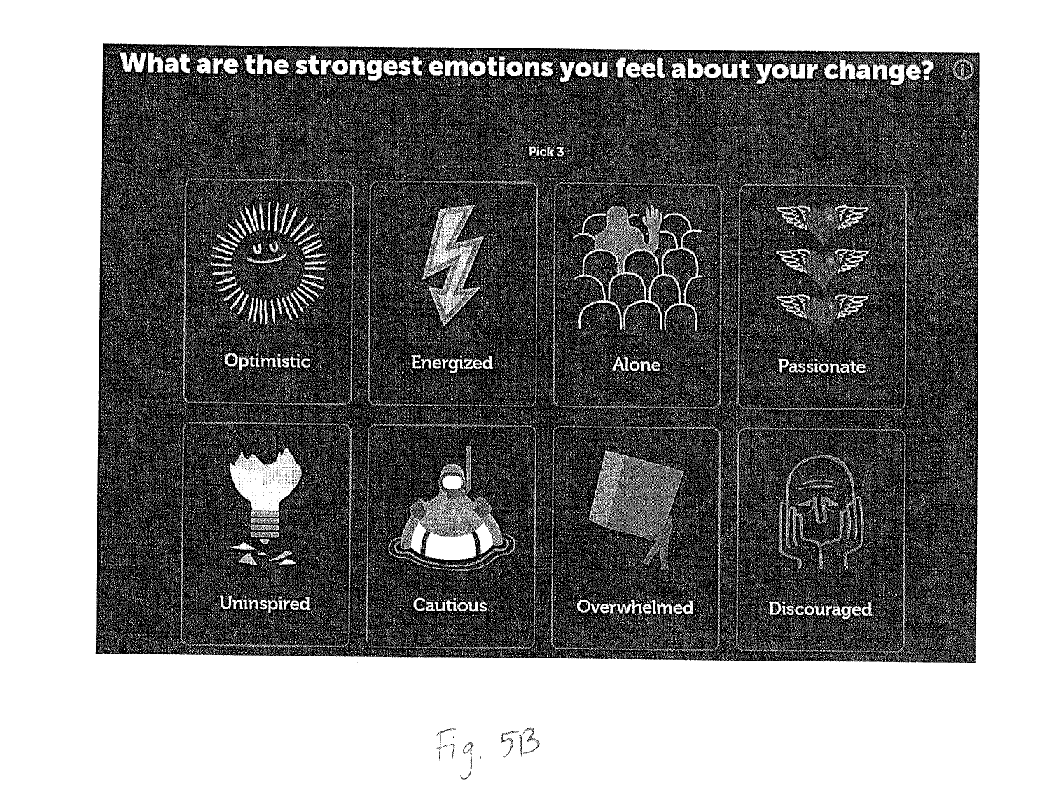

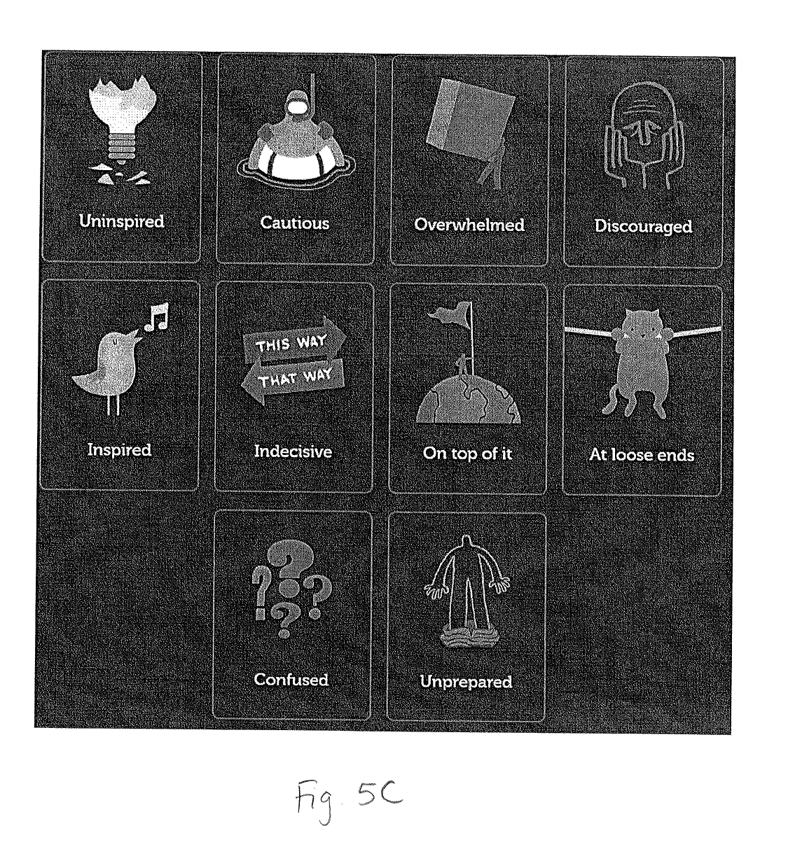

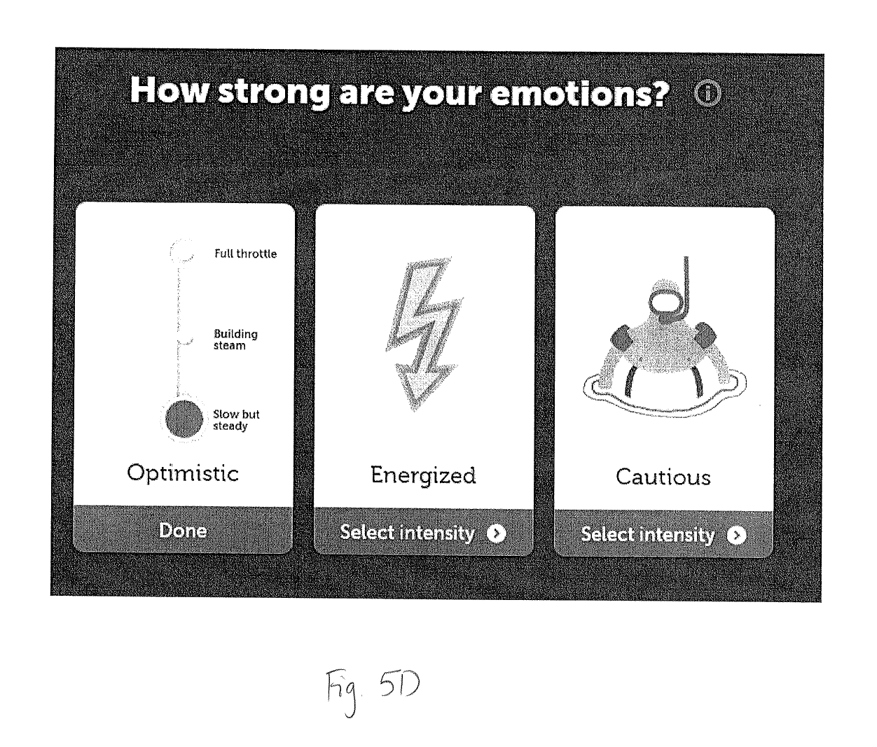

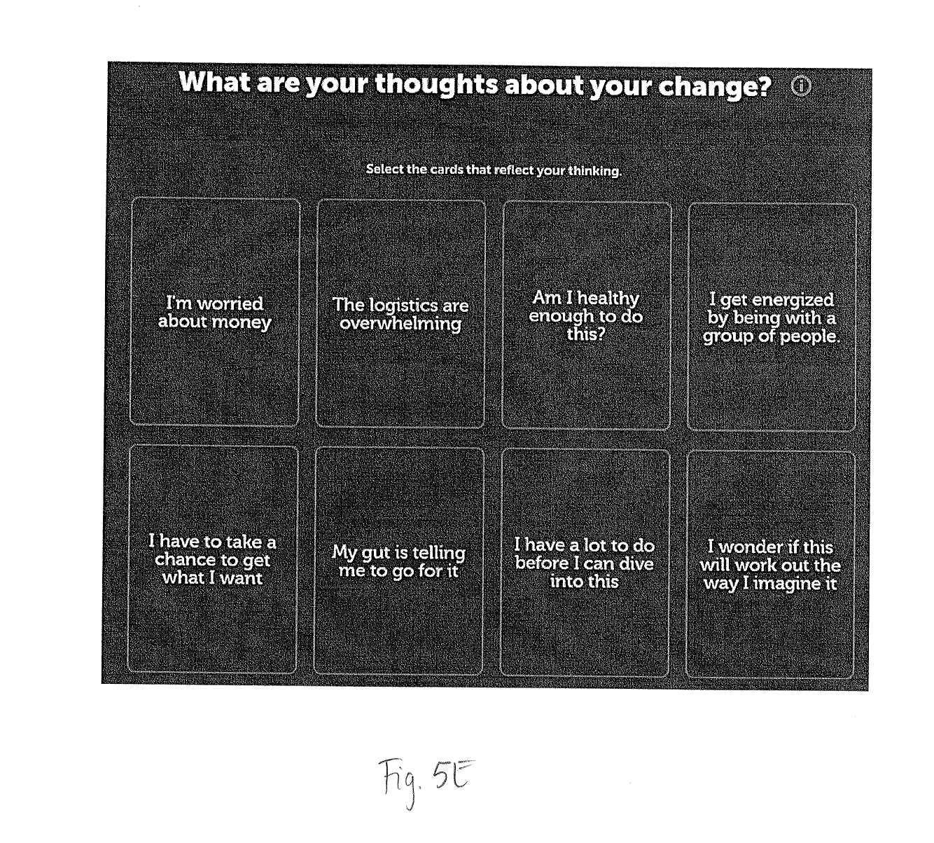

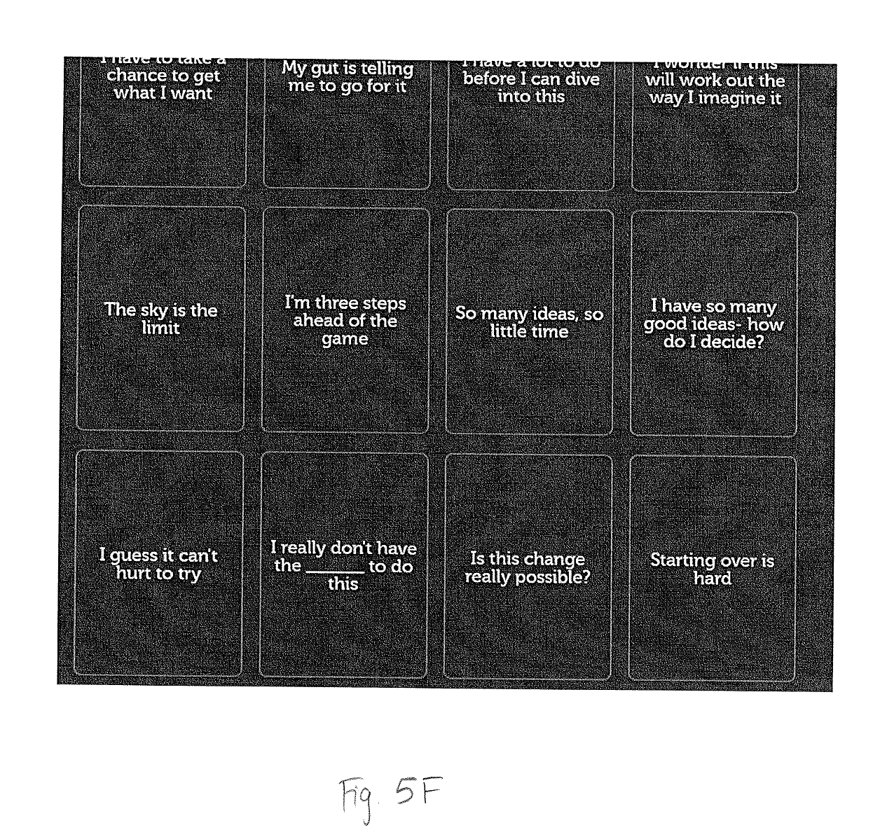

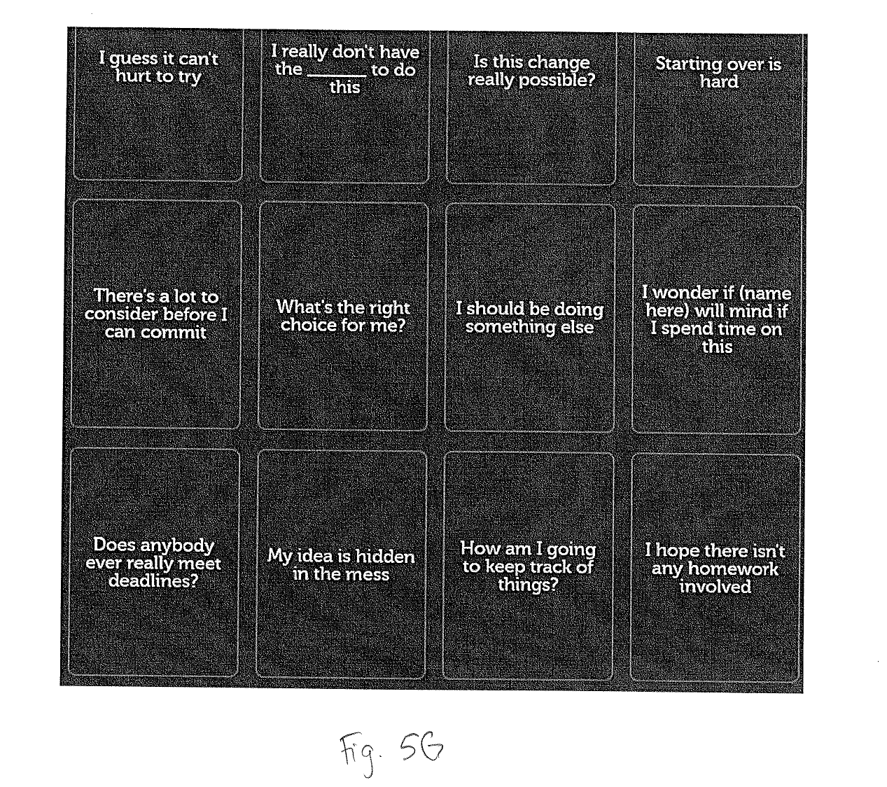

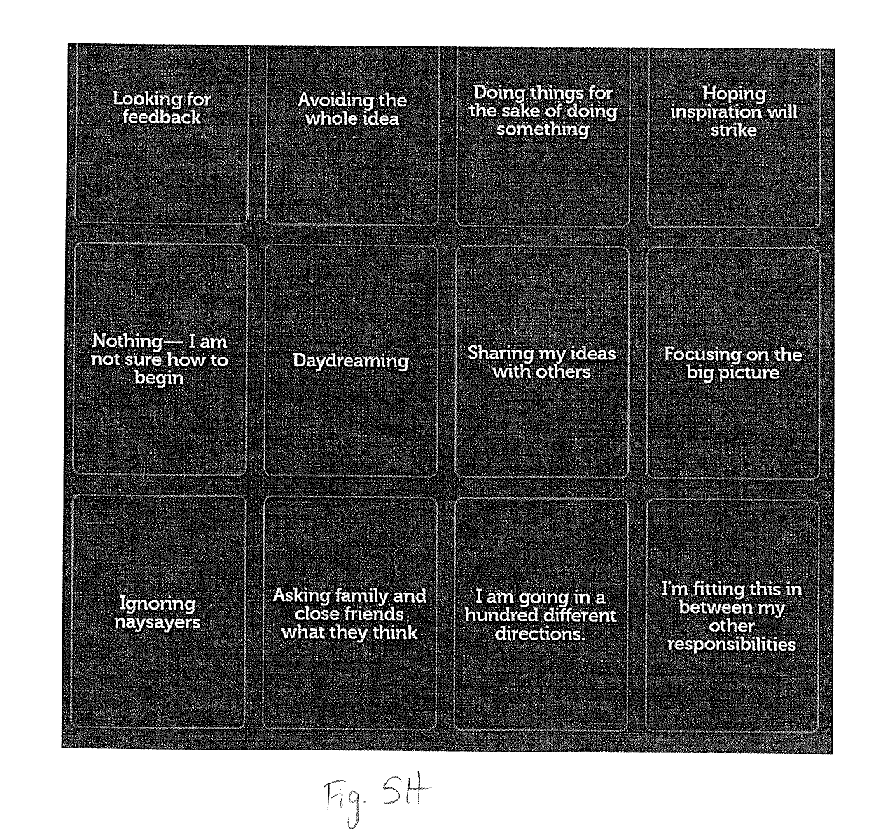

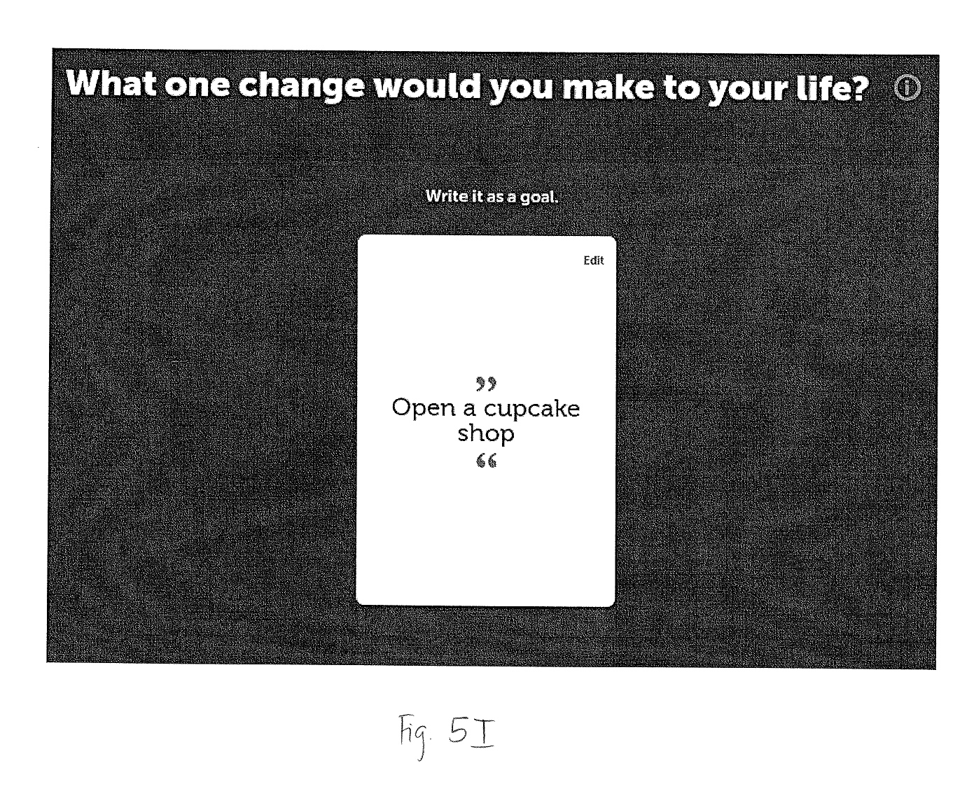

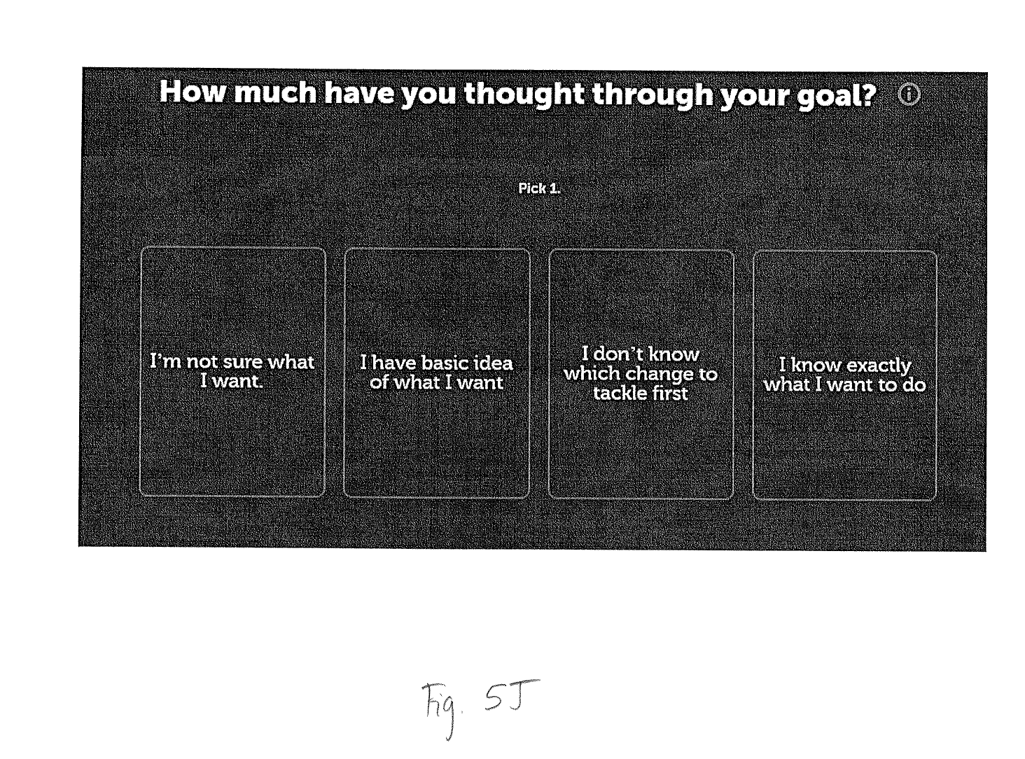

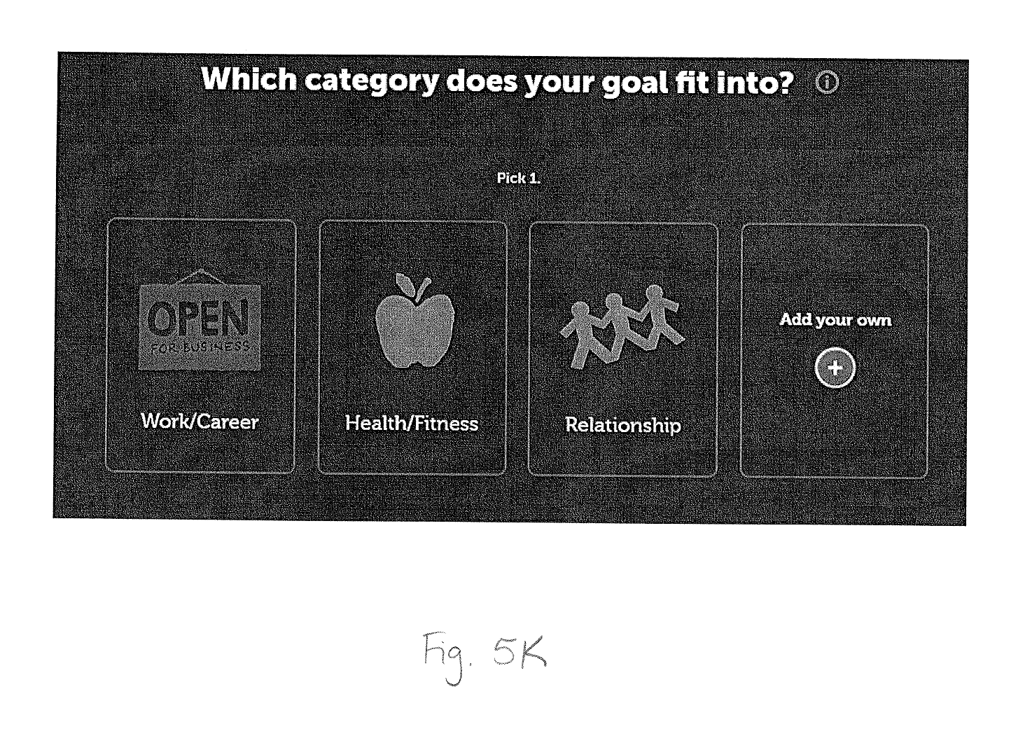

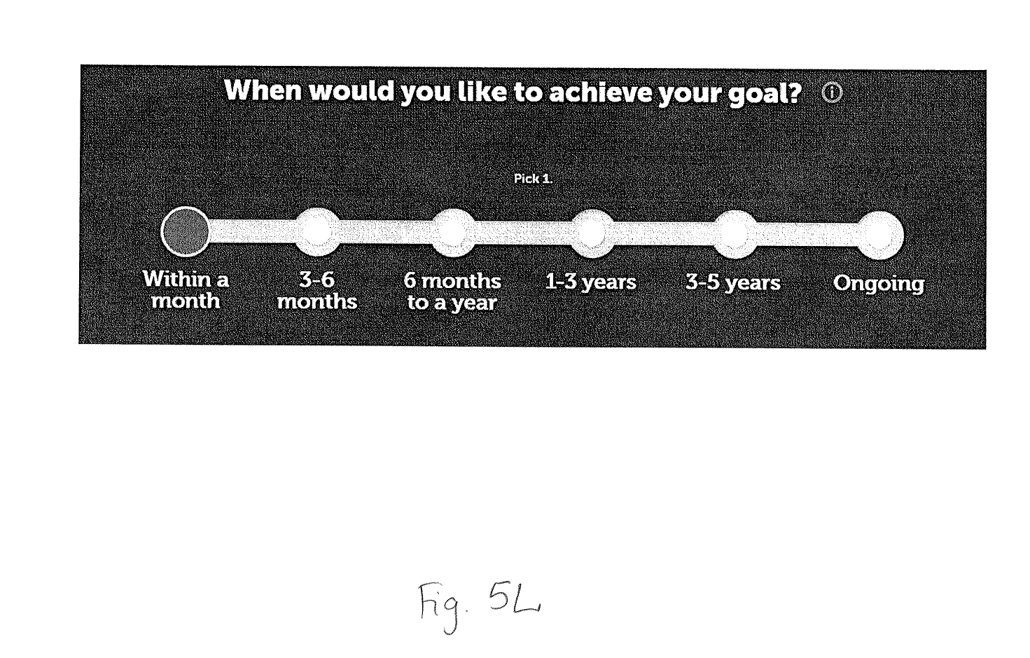

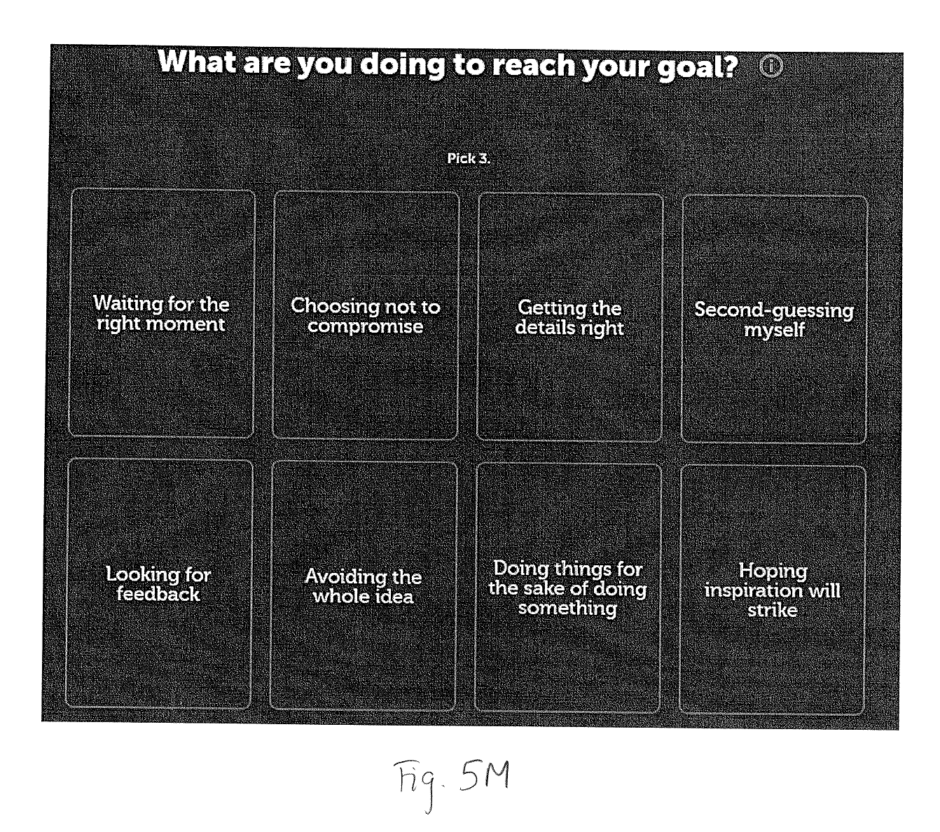

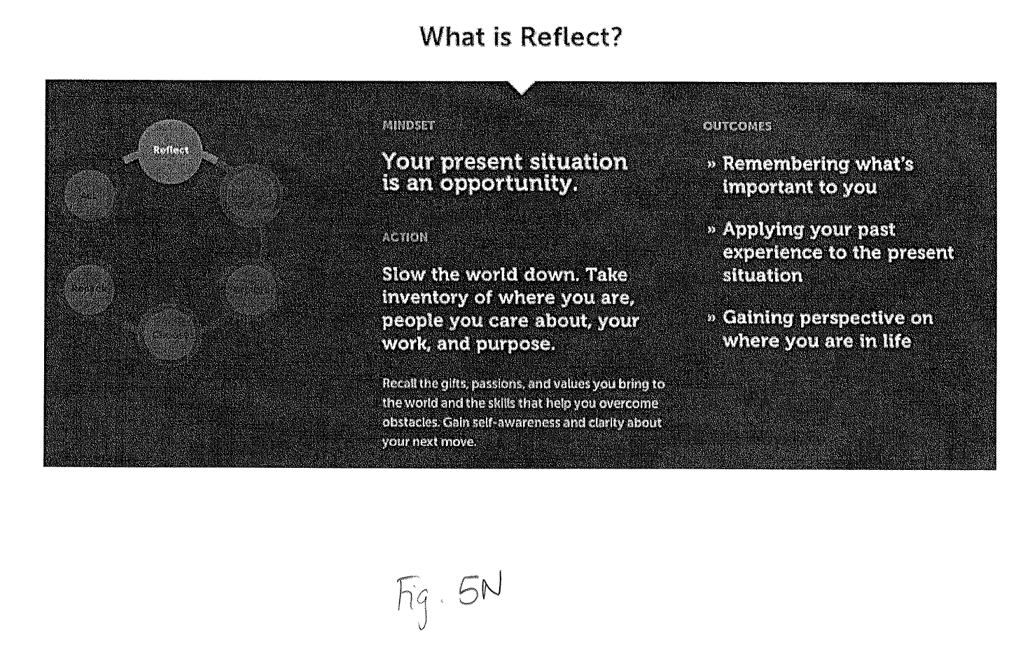

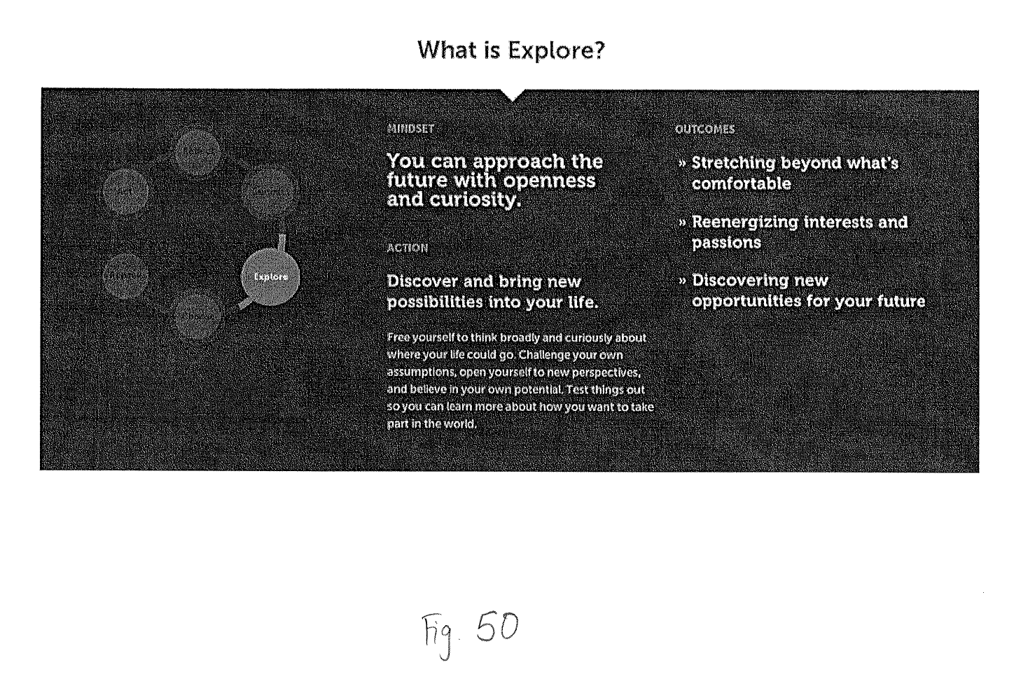

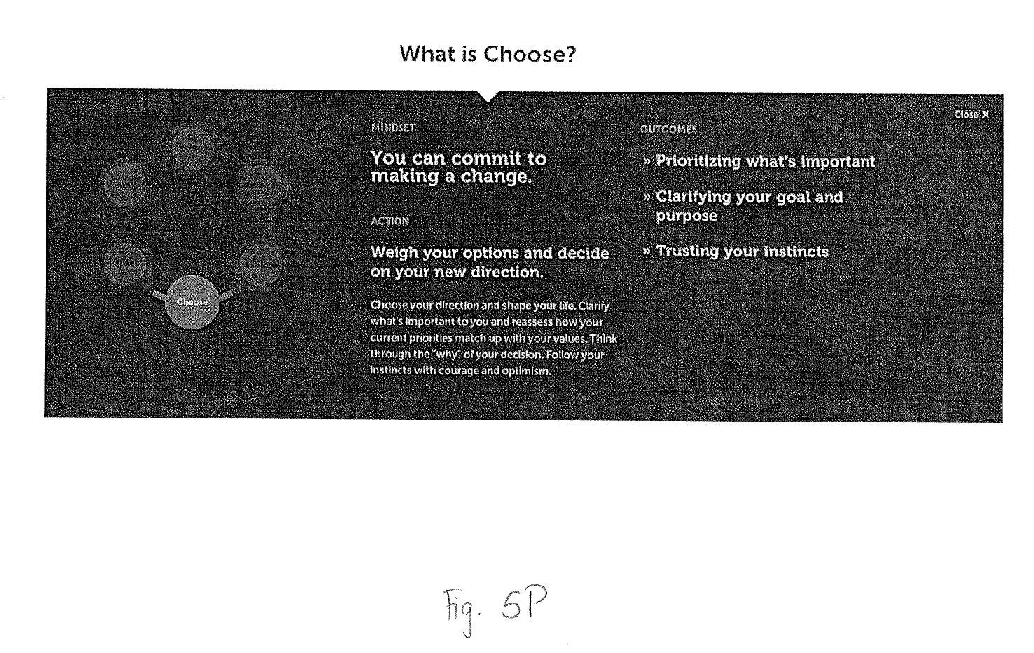

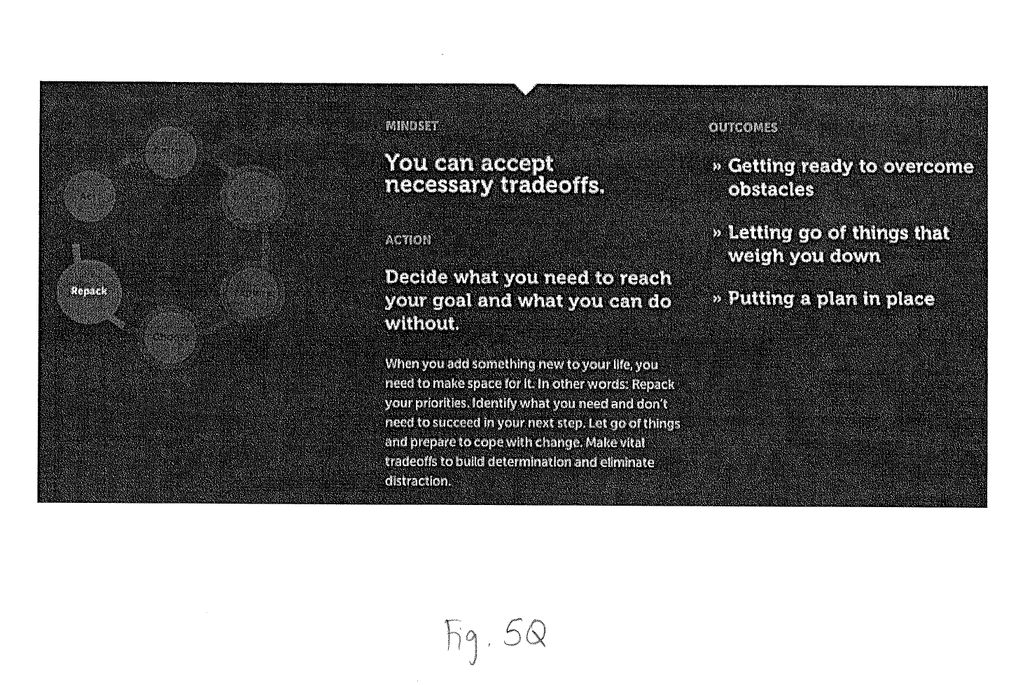

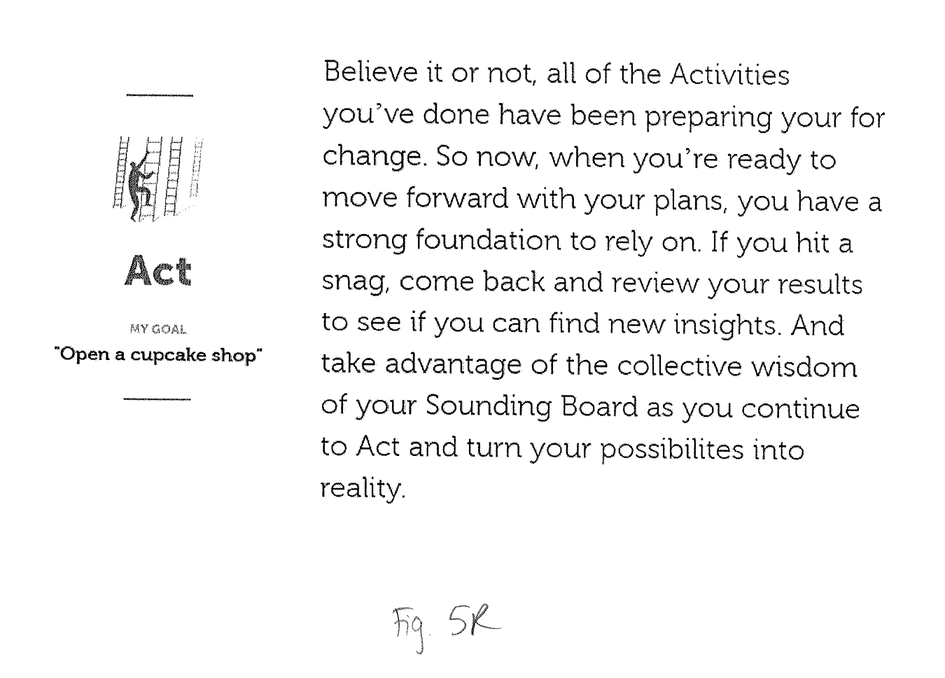

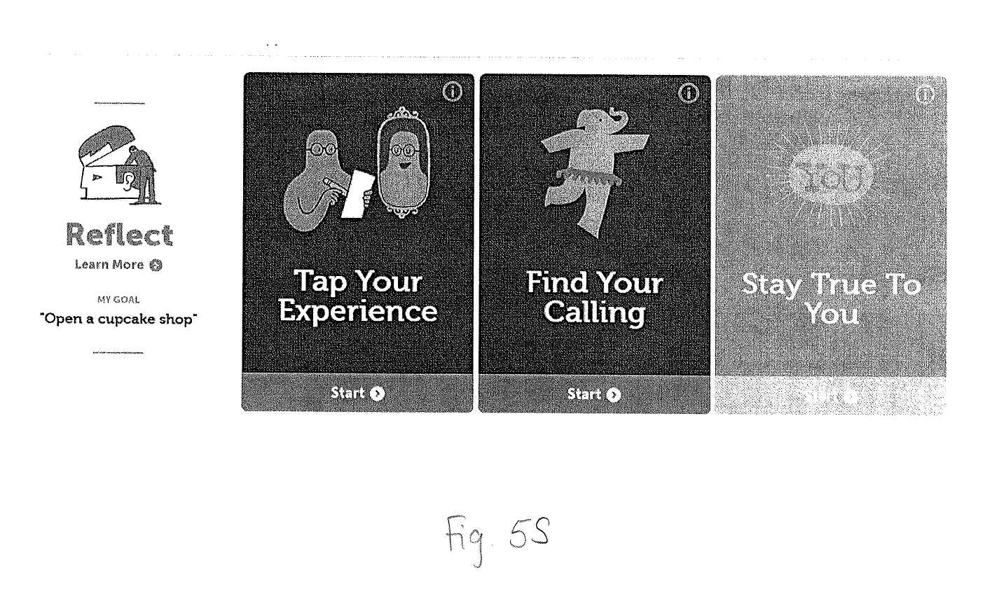

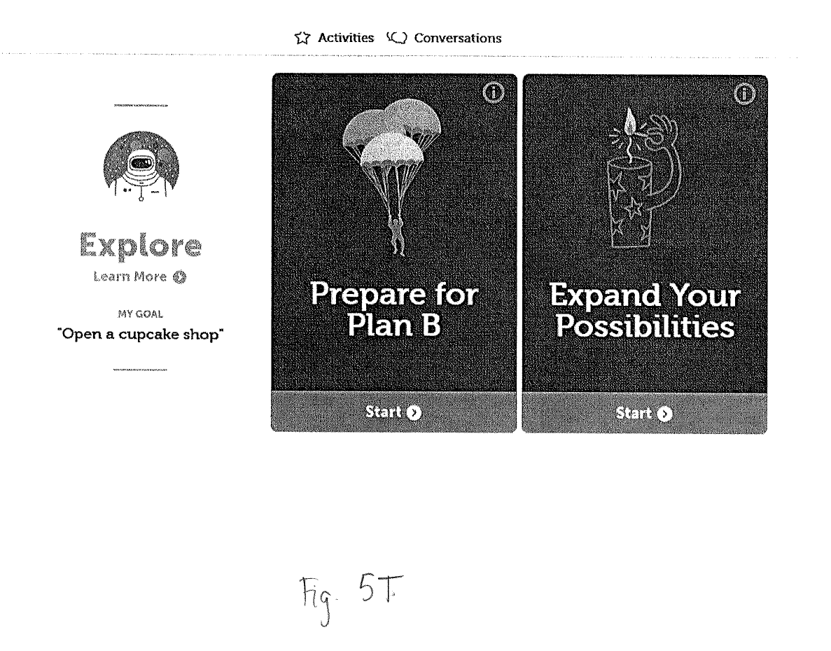

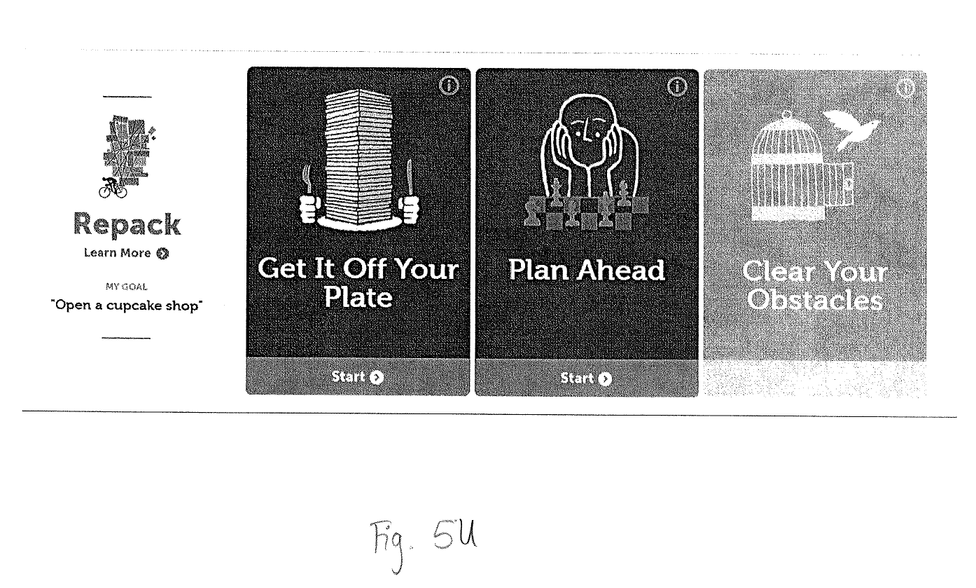

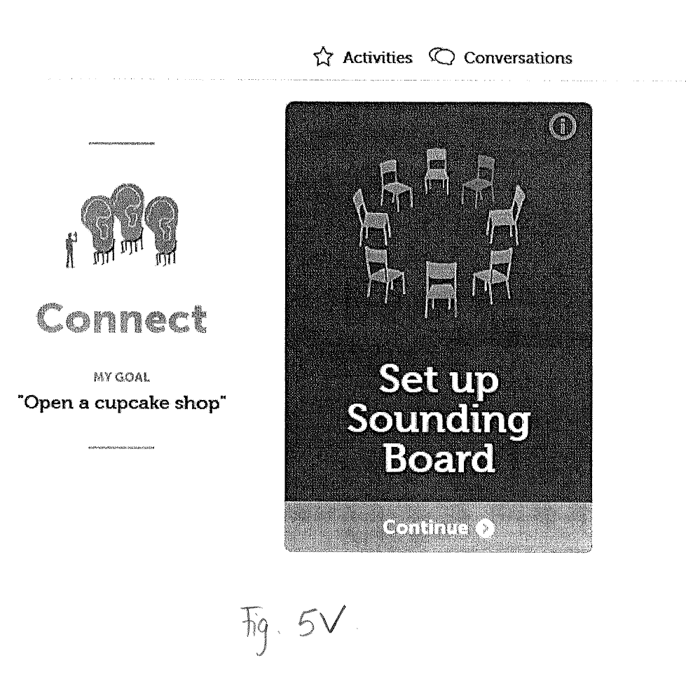

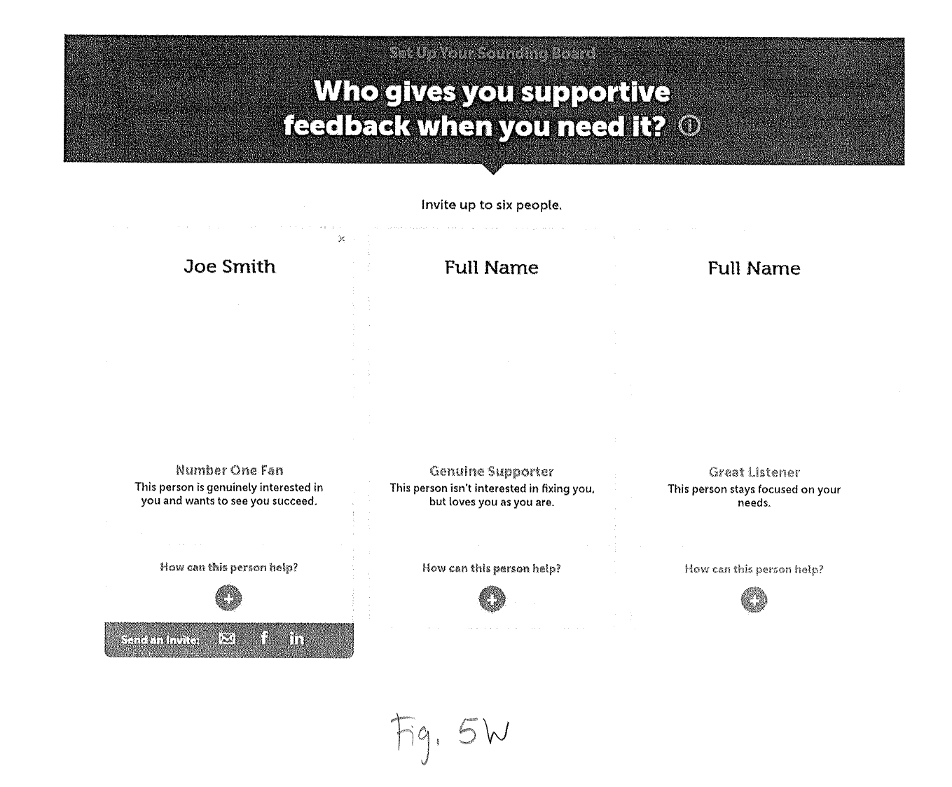

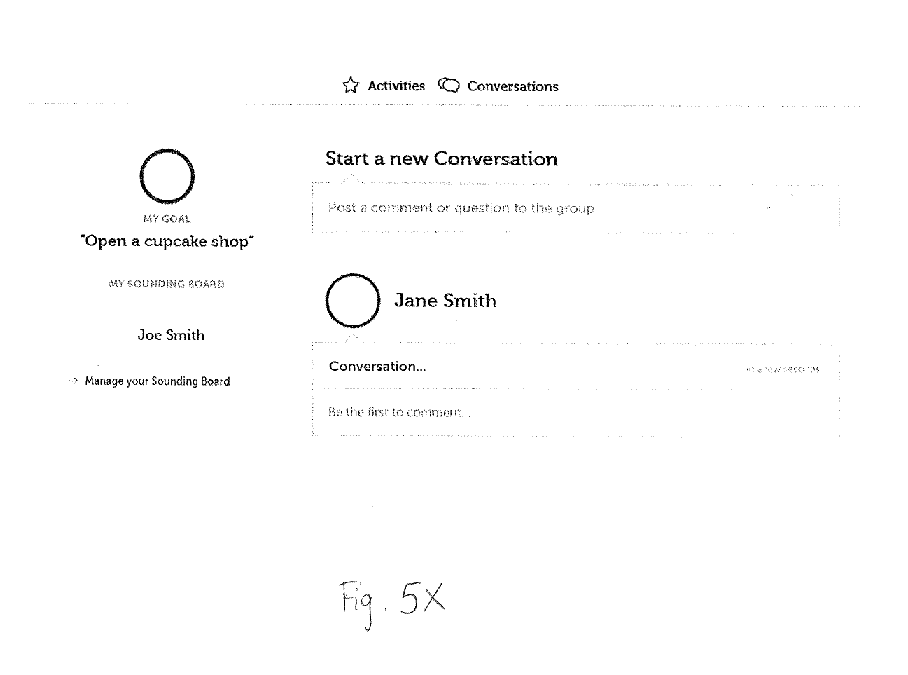

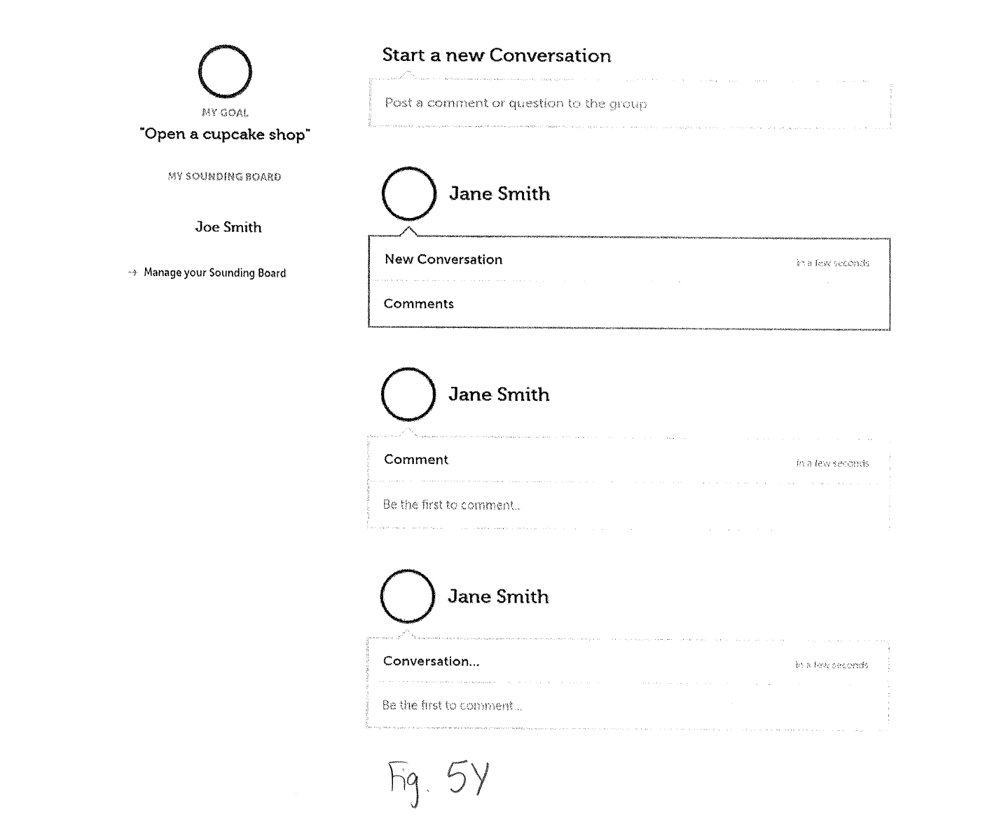

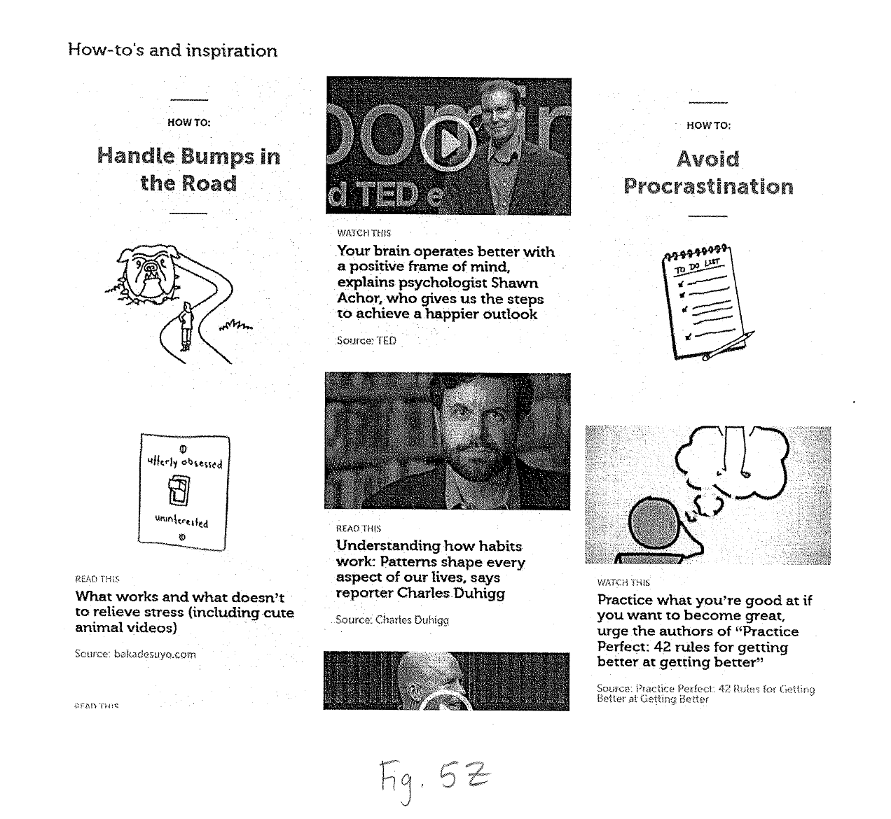

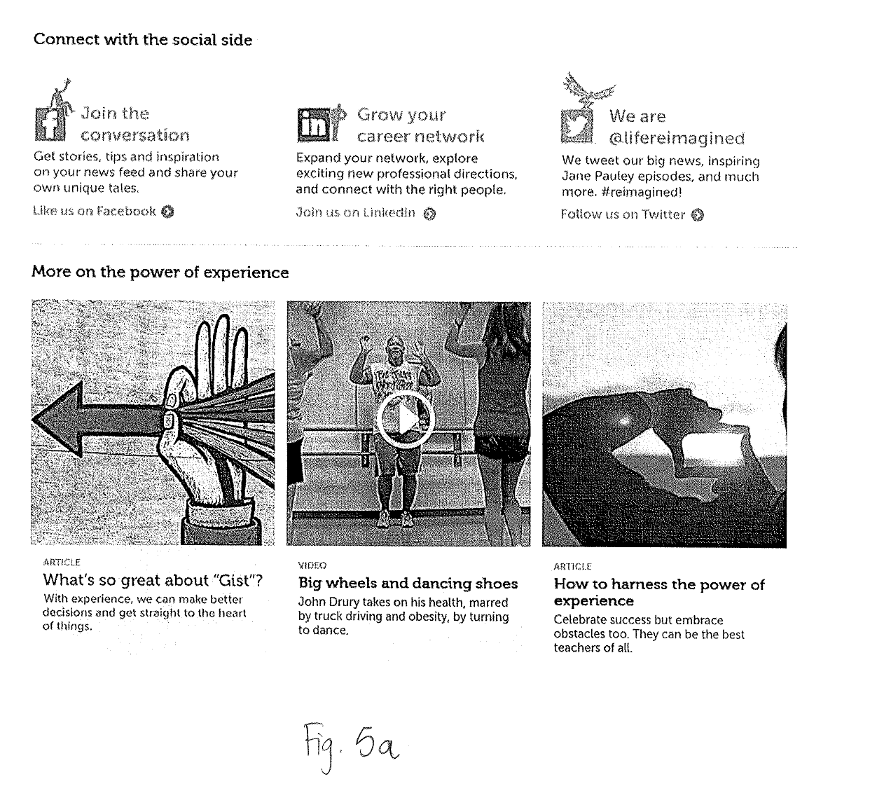

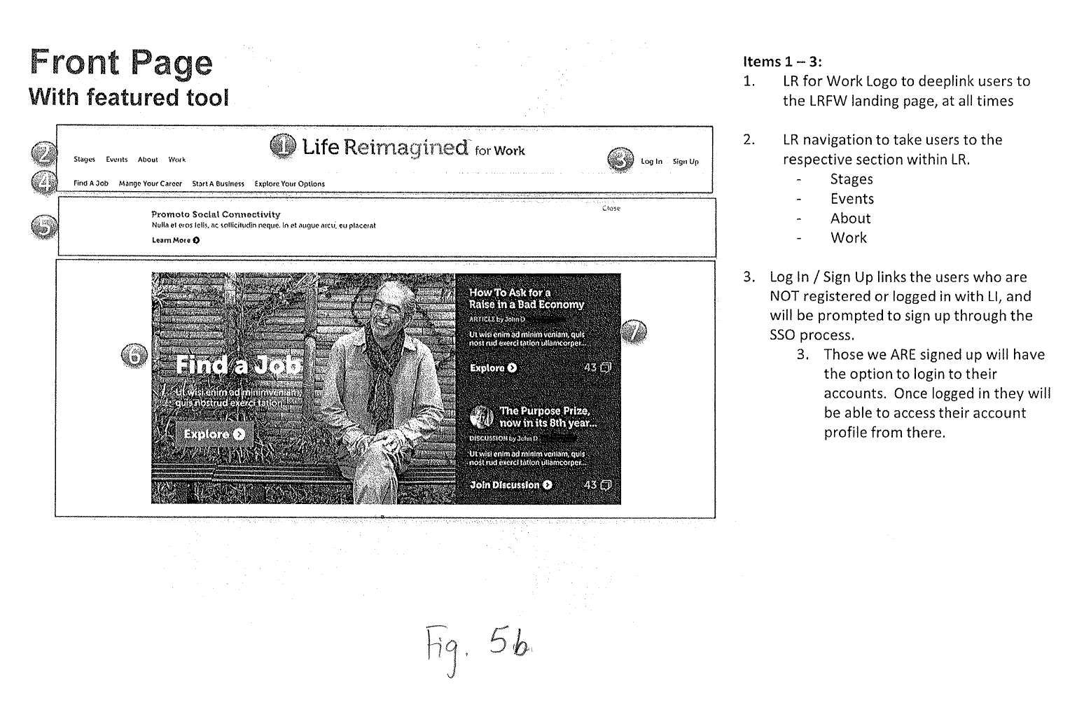

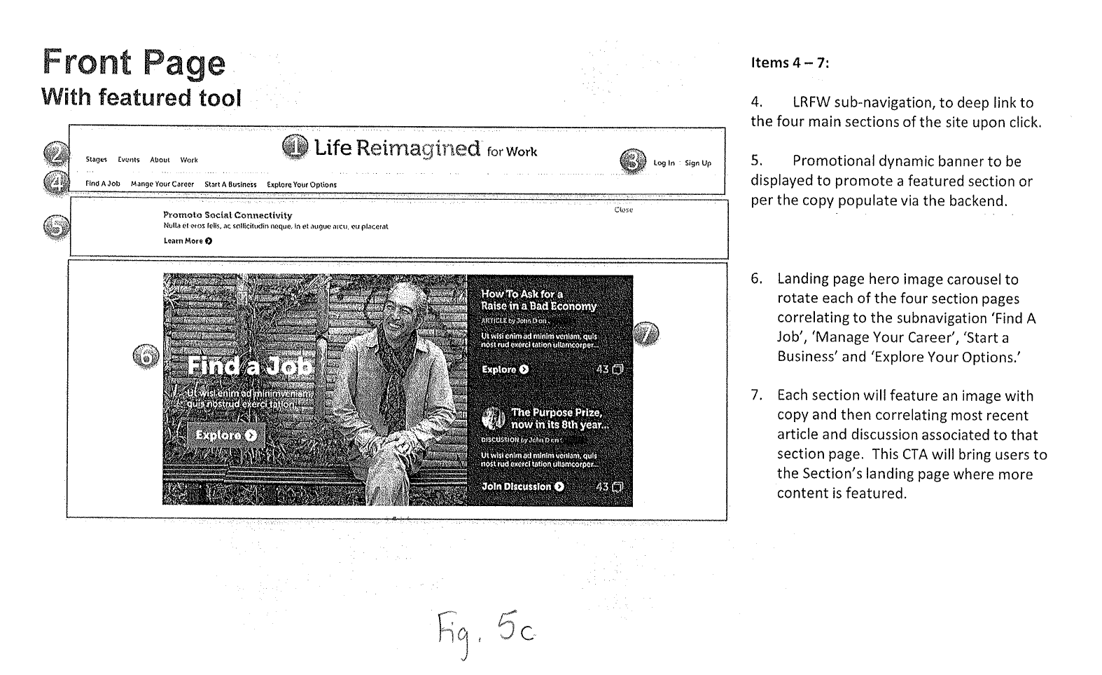

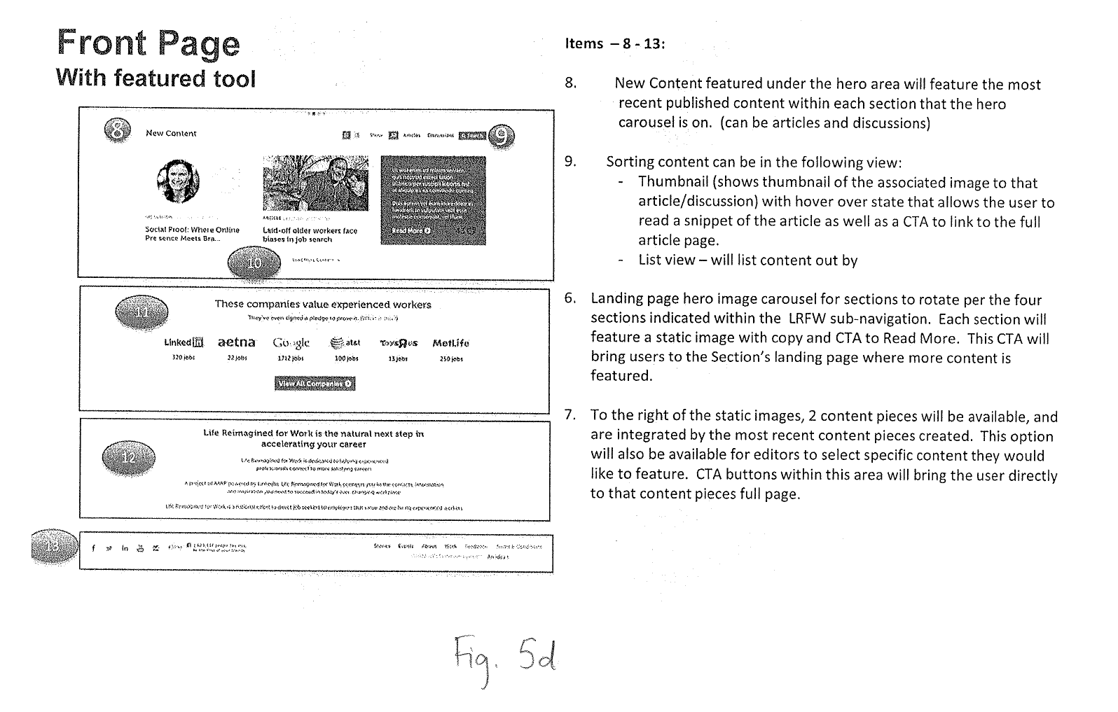

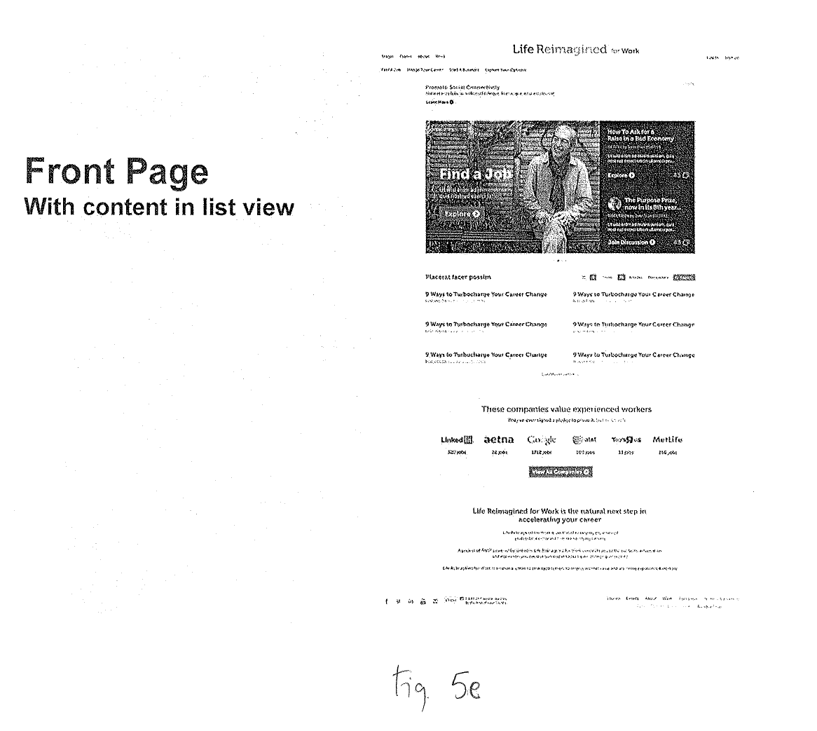

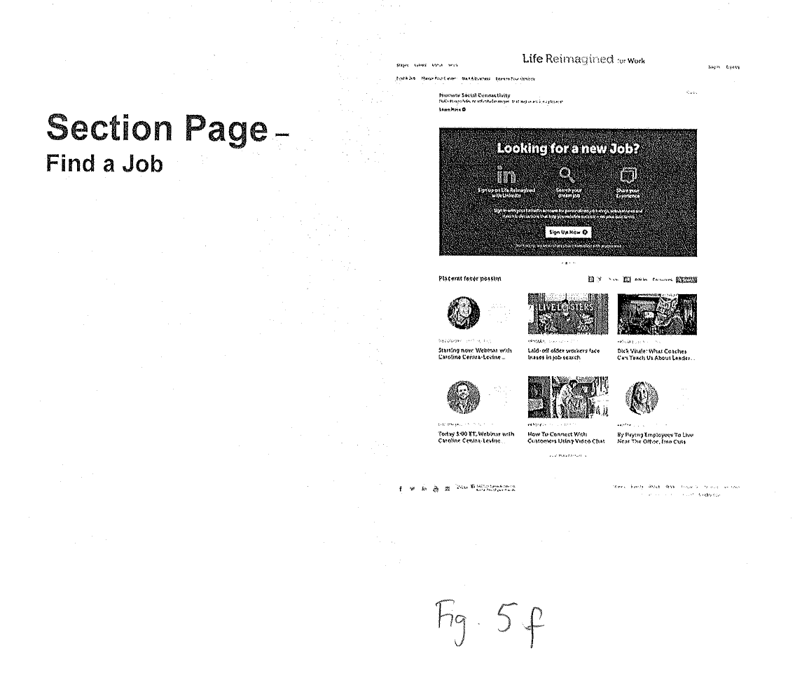

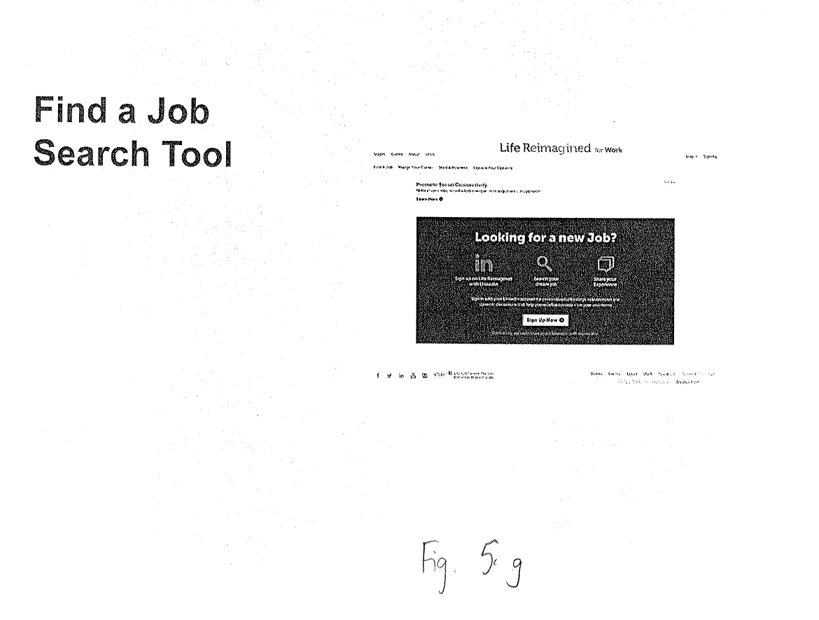

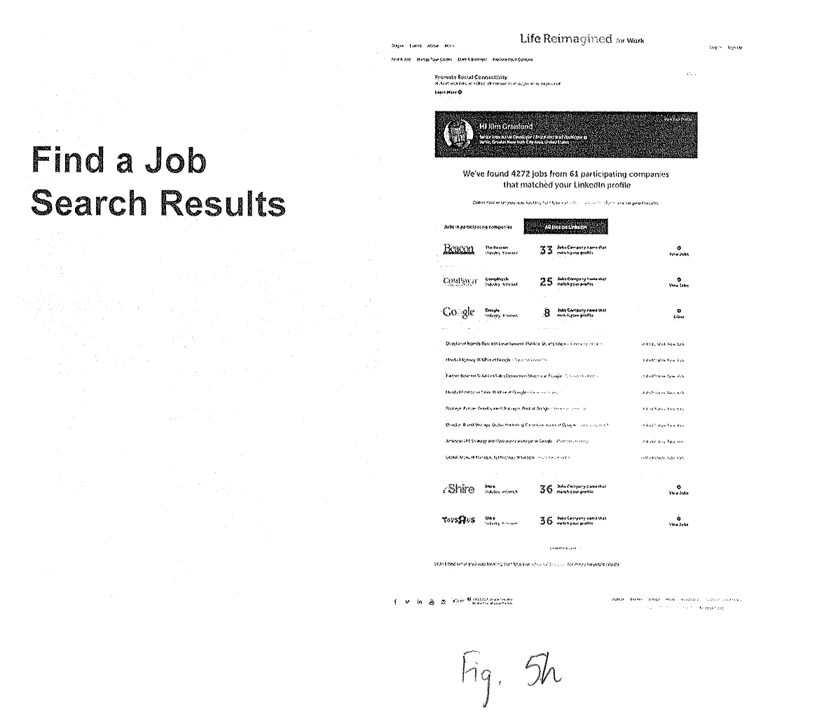

One variation of the system may include an interface that provides information about work, as illustrated, for example, in FIGS. 5b-5h. For example, the work interface may include content about finding a job, changing jobs, or gaining new skills, as illustrated, for example, in FIGS. 5b-5e. The content may include, but is not limited to, articles, other user stories, television show segments, and recommendations. The content may be original content or curated content. In addition, the work interface may allow a user to search for a new job and provide a job search results, as illustrated, for example, in FIGS. 5f-5h. Thus, a user of the system may access the work tab and receive tips and/or suggestions for finding a new job or changing jobs.

Referring now to FIGS. 5A-5Z and 5a-5h, illustrated therein are example graphical user interfaces (GUI) screens illustrating exemplary implementations of aspects of the present invention. For example, FIG. 5A illustrates an example registration process. A user may be able to register and set up a user account. The user account may include, for example, a user name, password, contact information for the user (e.g., e-mail address, mailing address, telephone number), content for making a change, sounding board information, discussions where a user is participating, content about finding a job, content tailored to the user, and job searches. In addition, a user may be able to link other accounts the user may have. For example, the user may be able to link social media accounts, such as LinkedIn, Facebook, and Twitter, to the user account.

FIGS. 5B-5M illustrate example interfaces that may be presented to a user during a diagnostic exercise. For example, 5B and 5C illustrate example emotions that may be presented to a user and that a user may select from regarding a change. FIG. 5D illustrates an example scale for determining a level of intensity a user may be feeling about a selected emotion. In addition, FIGS. 5E-5H illustrate example feelings and/or thoughts a user may select from regarding a change.

FIG. 5I illustrates an example interface for receiving a goal for the change. In an aspect, a user may type in a goal and/or may select a goal for a list of predefined goals. FIG. 5J illustrates example interfaces for determining how much a user may have thought about a goal and FIG. 5K illustrates an interface for presenting various categories for a goal. FIG. 5L illustrates an example interface for determining a level of urgency and expectation for a goal. In addition, FIG. 5M illustrates an example interface for determining actions, if any, that a user may have taken in reaching a goal.

FIGS. 5N-5R illustrate various stages of a change the system may determine for a user based upon the responses received during the diagnostic experience. FIGS. 5S-5V illustrate various actions that the system may suggest a user take based on a stage of change.

FIGS. 5W-5Y illustrate example interfaces for setting up a sounding board. For example, FIG. 5W illustrates an interface for selecting individuals to be invited to a sounding board. FIG. 5X illustrates an example interface for starting a conversation and FIG. 5Y illustrates an example interface of a threaded conversation.

FIG. 5Z illustrates example content that may be presented to a user to aid a user in achieving a goal or change. FIG. 5a illustrates an example of connecting with other individuals using the system.

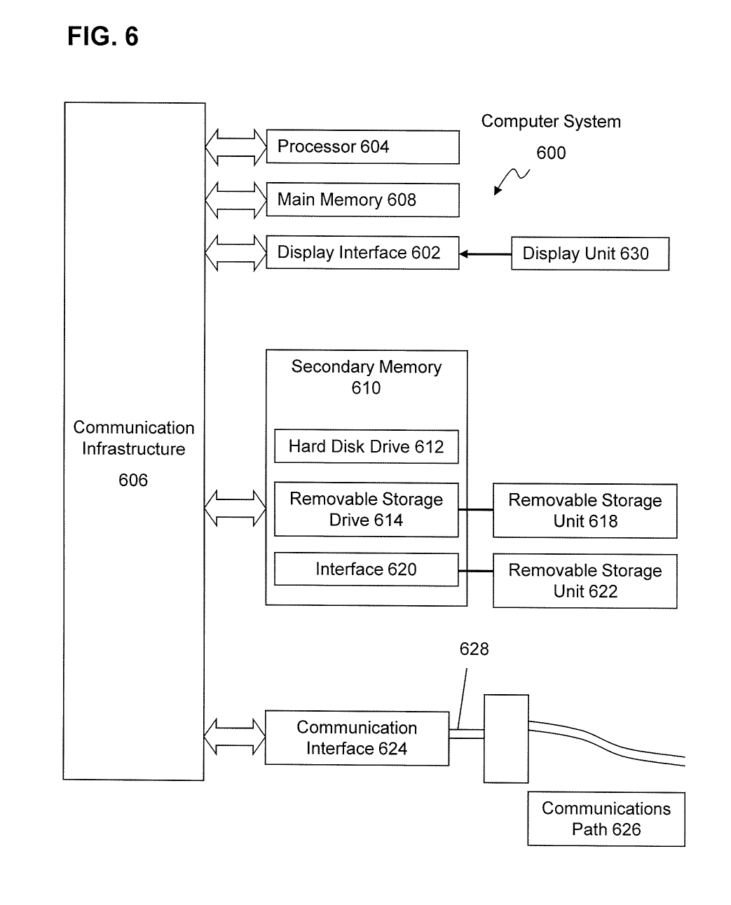

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 600 is shown in FIG. 6.

Computer system 600 includes one or more processors, such as processor 604. The processor 604 is connected to a communication infrastructure 606 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, a universal serial bus (USB) flash drive, etc. The removable storage drive 614 reads from and/or writes to a removable storage unit 618 in a well-known manner. Removable storage unit 618 represents a floppy disk, magnetic tape, optical disk, USB flash drive etc., which is read by and written to removable storage drive 614. As will be appreciated, the removable storage unit 618 includes a computer usable storage medium having stored therein computer software and/or data.

Alternative aspects of the present invention may include secondary memory 610 and may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 680, a hard disk installed in hard disk drive 670, and signals 628. These computer program products provide software to the computer system 600. Aspects of the invention are directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features in accordance with aspects of the present invention, as discussed herein. In particular, the computer programs, when executed, enable the processor 604 to perform the features in accordance with aspects of the present invention. Accordingly, such computer programs represent controllers of the computer system 600.

In an aspect of the present invention that is implemented using software, the software may be stored in a computer program product and loaded into computer system 600 using removable storage drive 614, hard drive 612, or communications interface 620. The control logic (software), when executed by the processor 604, causes the processor 604 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, features thereof is implemented using a combination of both hardware and software.

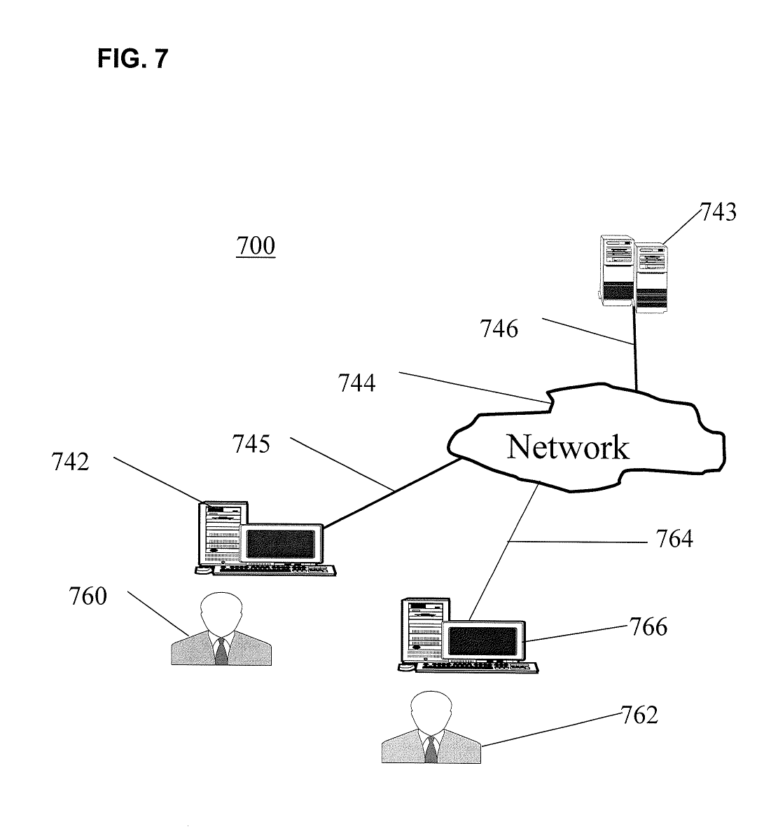

FIG. 7 shows a communication system 700 usable in accordance with aspects of the present invention. The communication system 700 includes one or more accessors 760, 762 (also referred to interchangeably herein as one or more “users”) and one or more terminals 742, 766. In one aspect of the present invention, data for use is, for example, input and/or accessed by accessors 760, 764 via terminals 742, 766, such as personal computers (PCs), minicomputers, mainframe computers, microcomputers, telephonic devices, or wireless devices, such as personal digital assistants (“PDAs”) or a hand-held wireless devices coupled to a server 743, such as a PC, minicomputer, mainframe computer, microcomputer, or other device having a processor and a repository for data and/or connection to a repository for data, via, for example, a network 744, such as the Internet or an intranet, and couplings 745, 746, 764. The couplings 745, 746, 764 include, for example, wired, wireless, or fiberoptic links. In another variation the present invention, the method and system in accordance with aspects of the present invention operate in a stand-alone environment, such as on a single terminal.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

1. A method for facilitating a change for an individual, the method executed on an apparatus comprising a processor, the method comprising:
receiving information associated with making a change;
performing a calculation based upon the received information to determine the current stage of change;
determining, via a processor, whether an individual is in a reflect stage of change based on the calculation;
determining, via the processor, whether the individual is in a connect stage of change based on the calculation;
determining, via the processor, whether the individual is in an explore stage of change based on the calculation;
determining, via the processor, whether the individual is in a choose stage of change based on the calculation;
determining, via the processor, whether the individual is in a repack stage of change based on the calculation;
determining, via the processor, whether the individual is in an act stage of change based on the calculation; and
transmitting for output a current stage of change for the individual based upon the determined results.

2. The method of claim 1, further comprising:
providing one or more actions based upon the current stage of change.

3. The method of claim 2, wherein an action includes setting up a sounding board.

4. A method for setting up a sounding board, the method executed on an apparatus comprising a processor, the method comprising:
receiving a selection of individuals to include in a sounding board;
transmitting an invite for the sounding board to each of the selected individuals; and
establishing the sounding board with each of the individuals that accept the invite.

5. The method of claim 4, further comprising:
receiving content from the individuals; and
sharing the content among the individuals of the sounding board.

6. The method of claim 4, further comprising:
establishing one or more conversations among the individuals of the sounding board.

7. An apparatus for facilitating a change for an individual, comprising:
a change management component configured to receive information associated with making a change;
a calculator component configured to perform a calculation based upon the received information to determine the current stage of change, wherein the calculator component is further configured to:
determine whether an individual is in a reflect stage of change based on the calculation;
determine whether the individual is in a connect stage of change based on the calculation;
determine whether the individual is in an explore stage of change based on the calculation;
determine whether the individual is in a choose stage of change based on the calculation;
determine whether the individual is in a repack stage of change based on the calculation;
determine whether the individual is in an act stage of change based on the calculation; and
the change management component configured to transmit for output a current stage of change for the individual based upon the determined results.

8. The apparatus of claim 7, wherein the change management component provides one or more actions based upon the current stage of change.

9. The apparatus of claim 8, wherein an action includes setting up a sounding board.

10. An apparatus for setting up a sounding board, comprising:
a sounding board component operable to receive a selection of individuals to include in a sounding board; transmit an invite for the sounding board to each of the selected individuals; and establish the sounding board with each of the individuals that accept the invite.

11. The apparatus of claim 10, wherein the sounding board component is further operable to receive content from the individuals; and share the content among the individuals of the sounding board.

12. The apparatus of claim 10, wherein the sounding board component is further operable to establish one or more conversations among the individuals of the sounding board.

13. A computer program product, comprising:
a computer-readable medium comprising:
at least one instruction for causing a computer to receive information associated with making a change;
at least one instruction for causing the computer to perform a calculation based upon the received information to determine the current stage of change;
at least one instruction for causing the computer to determine whether an individual is in a reflect stage of change based on the calculation;
at least one instruction for causing the computer to determine whether the individual is in a connect stage of change based on the calculation;
at least one instruction for causing the computer to determine whether the individual is in an explore stage of change based on the calculation;
at least one instruction for causing the computer to determine whether the individual is in a choose stage of change based on the calculation;
at least one instruction for causing the computer to determine whether the individual is in a repack stage of change based on the calculation;
at least one instruction for causing the computer to determine whether the individual is in an act stage of change based on the calculation; and
at least one instruction for causing the computer to transmit a current stage of change for the individual based upon the determined results for output.

14. A computer program product, comprising:
a computer-readable medium comprising:
at least one instruction for causing a computer to receive a selection of individuals to include in a sounding board;
at least one instruction for causing the computer to transmit an invite for the sounding board to each of the selected individuals; and
at least one instruction for causing the computer to establish the sounding board with each of the individuals that accept the invite.
